(19) United States
(12) Patent Application Publication
(10) Pub. No.: US 2005/0098915 A1
(43) Pub. Date: May 12, 2005

(54) Manufacture of bone graft substitutes

(75) Inventors: Marc Long, Memphis, TN (US); Jeff Holbrook, Memphis, TX (US); Ed Margerrison, Germantown, TN (US)

Correspondence Address: SMITH & NEPHEW, INC., 1450 E. BROOKS ROAD, MEMPHIS, TN, 38116, US

(73) Assignee: Smith & Nephew Inc., Memphis, TN (US)

(21) Appl. No.: 10/704,420

(22) Filed: Nov. 7, 2003

(51) Int. Cl. B29C 43/02

(52) U.S. Cl. 264/109; 425/354; 425/412

(57) ABSTRACT

The present invention is directed to methods and compositions for manufacturing a bone graft substitute. A powder compaction process is utilized to generate a shaped product comprised of a bone material and in some embodiments a processing aid is utilized to facilitate compaction of the bone material and/or for release of the product from the die. In one aspect of the present invention, the manufacturing process comprises a withdrawal press having a shelf die, a lower punch, and an upper punch, wherein at least both the shelf die and lower punch are configured to impart at least part of the shape of the particle upon the material.

### FIELD OF THE INVENTION

The present invention is directed to compositions and methods for making bone graft substitutes. More specifically, the present invention is directed to manufacturing a bone graft substitute (BGS) by powder compaction utilizing a shelf die and at least one punch, both of which impart a relief profile upon bone material to manufacture the shape of the BGS.

### BACKGROUND OF THE INVENTION

Bone graft is used to fill spaces in bone tissue that are the result of trauma, disease degeneration or other loss and/or defect of tissue. Clinicians perform bone graft procedures for a variety of reasons, often to fill a bone void created by a loss of bone, compaction of cancellous bone, and/or correction or improvement of bone. In many instances, the clinician also must rely on the bone graft material to provide some mechanical support, as in the case of subchondral bone replacement or compaction grafting around total joint replacement devices. In these instances, clinicians pack the material into the defect to create a stable platform to support the surrounding tissue and hardware.

There are several options available to the orthopaedic clinician for bone graft material. Most commonly, the source of the graft material is either the patient (autograft), which is clinically preferable, or a donor (allograft). However, autograft has the potential drawback of increased pain and morbidity associated with a second surgical procedure, in addition to having a limited supply of the bone. In autograft and, to a lesser extent, in allograft there are biological factors such as proteins or cells that are present that can assist in the fracture healing process. Xenografts and synthesized BGS are other options.

Moreover, synthetically derived substitute material has advantages over human-derived bone graft and naturally-derived substitutes, including: 1) more control over product consistency; 2) less risk for infection and disease; 3) no morbidity or pain caused by harvesting of the patient's own bone for graft; and 4) availability of the substitute in many different volumes (that is, it is not limited by harvest site of the patient).

The BGS materials that have been used commercially exhibit various levels of bioactivity and various rates of dissolution. BGS products are currently available in several forms: powder, gel, slurry/putty, tablet, chips, morsels, and pellet, in addition to shaped products (sticks, sheets, and blocks). In many instances, the form of BGS products is dictated by the material from which the products are made. Synthetic materials (such as calcium sulfates or calcium phosphates) have been processed into several shapes (tablets, beads, pellets, sticks, sheets, and blocks, for example) and may be used as scaffolds or delivery vehicles for additives such as antibiotics. Allograft products, in which the source of the bone graft material is a donor, are typically available as chips and can be mixed with a gel to form a composite gel or putty. None of the current products and technologies offered for BGS is capable of offering an allograft granule or shape for easy delivery and scaffold structure, in addition to being conformable to the surgical site. Furthermore, none but one (Osteoset®-T) of the current products and technologies offered for BGS is capable of offering an allograft or synthetic granule or shape containing a bioactive agent or agents, such as an antibiotic or bone morphogenetic proteins.

As stated, past solutions to produce BGS products have included gel, putty, paste, formable strips, blocks, granules, chips, pellets, tablets, and powder. A skilled artisan recognizes there are multiple references directed to bone graft substitutes, including Medica Data International, Inc., Report #RP-591149, Chapter 3: Applications for Bone Replacement Biomaterials and Biological Bone Growth Factors (2000) and Orthopaedic Network News, Vol. 11, No 4, October 2000, pp. 8-10. However, it is a disadvantage of most presently available products to have no shape that provides significant stability, such as by interlocking. Furthermore, the irregularly-shaped chips of presently available products do not compact sufficiently and also fail to generate reproducible results. Other calcium sulfate-based products have been made using a casting or molding process, as opposed to a dry powder compaction process of the present invention. For example, Osteoset®-T pellets are likely to have been tableted because of their simple shape. A more complicated shape that could provide improved interlocking between the granules over the tableting process used in the art requires the use of a more advanced manufacturing process.

The manufacturing of JAX® (Smith+Nephew, Inc.; Memphis, Term.) bone void filler, described at least in part in U.S. Pat. No. 6,630,153 and WO 02/067820, both of which are incorporated by reference herein in their entirety, requires the use of a powder compaction process to be able to produce the advanced interlocking granule shape. Although U.S. Pat. No. 6,630,153 is directed to a method of manufacturing a three-dimensional intricately shaped bone graft substitute comprising the step of dry powder compacting a bone material into the three-dimensional intricate shape, for some particular embodiments, such as smaller sized substitutes, the method is not optimally suited. U.S. Pat. No. 6,630,153 and WO 02/067820, describe manufacture of a bone graft substitute by powder compaction. In particular embodiments, there are methods for manufacturing bone graft substitutes by providing a first punch assembly having a first contact surface configured to effect a relief profile onto a first surface of the granulated bone material; providing a second punch assembly having a second contact surface; providing a moveable die having at least one cavity; introducing the bone material into the cavity; positioning the moveable die generally in alignment with the first punch assembly; moving at least a portion of the first punch assembly to pressably contact the material in opposition to the second punch assembly to effect the desired relief profile on the first surface thereof; and moving at least a portion of the second punch assembly to pressably contact the material in opposition to the first punch assembly.

In additional particular embodiments of WO 02/067820, there is an apparatus for the manufacturing of a bone graft substitute from granulated bone material comprising a stationary lower punch; a moveable lower punch vertically moveable about the stationary lower punch; a moveable die having at least one cavity and positionable generally above the stationary lower punch; and a moveable upper punch, such that the moveable upper punch moves in opposition to the moveable lower punch to pressably contact the material contained within the cavity, whereupon following pressably contacting the material by the moveable lower punch the top surface height of the lower moveable punch is above the top surface height of the stationary lower punch.

U.S. Pat. Nos. 6,030,636; 5,807,567; and 5,614,206 are directed to calcium sulfate controlled release matrix. They provide forming a pellet prepared by the process comprising mixing powder consisting essentially of alpha-calcium sulfate hemihydrate, a solution comprising water, and, optionally, an additive and a powder consisting essentially of beta-calcium sulfate hemihydrate to form a mixture, and forming the mixture into the pellet. The pellets were formed by pouring a slurry mixture of the desired components into cylindrical molds.

U.S. Pat. Nos. 5,569,308 and 5,366,507 regard methods for use in bone tissue regeneration utilizing a conventional graft material/barrier material layered scheme. The barrier material is a paste formed immediately prior to its use by mixing calcium sulfate powder with any biocompatible, sterile liquid, whereas the graft material is also a paste form comprised of a mixture of water and at least autogenous cancellous bone, DFDBA, autogenous cortical bone chips, or hydroxylapatite.

U.S. Pat. No. 4,619,655 is directed to Plaster of Paris as a bioresorbable scaffold in implants for bone repair. The inventors provide an animal implant composed of a binder lattice or scaffold of Plaster of Paris and a non-bioresorbable calcium material such as calcium phosphate ceramic particles and, in a specific embodiment, the implant may contain an active medicament bound within the plaster. The implant composition of the invention may be preformed into the desired shape or shapes or it may be made up as a dry mix that can be moistened with water just prior to use to provide a fluid or semisolid, injectable formulation which can be injected into the appropriate body space as required for bone reconstruction.

U.S. Pat. No. 4,384,834 is directed to devices for compacting powder into a solid body, comprising a compaction chamber, a moveable support for the powder that extends into the compaction chamber, and means for launching a punch against the powder to form the solid body. The compaction chamber is formed by a block having a conical bore and a conical sleeve having a continuous uncut sidewall moveable within the conical bore to be radially compressed thereby.

U.S. Pat. No. 5,449,481 concerns an apparatus and methods for producing a powder compact comprising loading a rubber mold having a cavity shaped according to a desired configuration of the powder compact into a recess formed by a die, in addition to a lower punch inserted into the die. The method steps include filling a cavity of the rubber mold with powder, placing an upper punch in contact with an opposing surface of the die, and pressing the rubber mold filled with powder in a space formed by the die, the lower punch and the upper punch. In specific embodiments, the upper or lower punches are secured.

U.S. Pat. No. 5,762,978 is directed to a batching device having a series of die holes which are fed powder or granular material, upper and lower punches for each die hole, wherein the punches have counterfacing respective working heads, in addition to a rotary turret comprising the die holes, and driving means for adjusting distances between the working heads of the punches. The driving means includes a driving cam for at least one of the punches and filling operation cam means.

U.S. Pat. No. 6,106,267 regards tooling for a press for making an ingestible compression molded product, such as a tablet, from a granular feedstock material wherein the tooling comprises a die having a cylindrical die cavity and an open end for introducing the feedstock, and first and second punches with end faces which compress the feedstock material and which thereby would form the product whose surfaces conform to the end faces of the punches. The tip portion of the first punch is formed of an elastically deformable material so as to undergo deformation upon compression of the feedstock and which includes a wiping ring for wiping the inner surface of the die cavity upon movement of the punch within the die.

WO 02/056929 regards an artefact preferably composed of calcium-phosphate-based ceramic material for use as an implant, wherein the artefact has a body having an outer surface layer of a calcium-phosphate-based material, with the outer surface layer having a surface area of at least 1.5 m²/g and a plurality of micropores in the outer surface layer, with the micropores having a maximum dimension of up to about 150 microns. Its manufacture comprises mixing calcium-phosphate-based material in powder form with a thermoplastic binder, granulating the mixture, forming a green compact from the mixture, and sintering the green compact. The formation of the green compact in particular embodiments may be effected by pressing, molding, or extruding the powder/binder mixture, in some parts.

U.S. Pat. No. 5,603,880 concerns methods and an apparatus for manufacturing tablets. Plastic polymer film is pressed to form receptacles and filled with a predetermined amount of a powder under a pressurized condition.

U.S. Pat. No. 6,177,125 regards methods for manufacturing coated tablets from tablet cores and coating granulate using a press having at least one compression chamber and a feed device for tablet cores, comprising adding a pasty tablet core to the coating granulate to be compressed and compressing the coating granulate and the tablet cores simultaneously in a single pressing step.

U.S. Pat. No. 5,654,003 is directed to methods of making a solid comestible by forming deformable particles in size from 150 to 2000 microns wherein the particles are compressible in a die and punch tableting machine by subjecting a feedstock comprising a sugar carrier material, wherein the compressed product possesses a rigid structure and has a hard surface which resists penetration and deformation.

U.S. Pat. No. 5,017,122 regards a rotary tablet press for molding tablets through compression of powders and granules having a plurality of dies that rotate around a central axis, multiple upper and lower punches rotatable with the dies, and means for introducing electrically charged lubricant particles onto the tablets.

U.S. Pat. No. 5,158,728 is directed to an apparatus for forming a two-layer tablet having a die table comprising multiple die stations, each die having a cylindrical cavity. The upper punch and lower punch has at least one insert sized and positioned on the upper punch means and lower punch means, respectively, to fit within the die cavity on the die on die table.

Thus, although presently available compositions and methods in the art provide bone graft substitute particles the present invention improves upon these compositions and methods by providing particles having consistent shapes that interrelate in a manner to impart a three-dimensional structure for strength and bone ingrowth. The present invention also provides both simpler means to manufacture the shapes and more appropriate means to produce shapes of smaller sizes.

### BRIEF SUMMARY OF THE INVENTION

The present invention is directed to a system and method that are useful for producing a three-dimensional intricately shaped bone graft substitute.

In an embodiment of the present invention, there is a method of manufacturing at least one shaped bone graft substitute comprising the steps of providing a bone material; and subjecting said bone material to a press, wherein said press comprises at least: a first punch comprising a configuration to impart at least a portion of the shape of said bone graft substitute to the bone material; a shelf die containing a cavity for receiving at least one punch, said cavity comprising: a shelf; a configuration to impart at least a portion of the shape of said bone graft substitute; and a configuration concentrically surroundable to said first punch and moveable axially thereabout; and a second punch, wherein said second punch is moveable into a part of said cavity, said part bounded by the shelf of the shelf die, wherein said second punch is opposable to the first punch, and wherein following said subjecting step a bone graft substitute having a substantially non-linear contour is manufactured. In a specific embodiment, the bone material comprises a powder. In another specific embodiment, the particles of the material comprising a powder are less than about 10 millimeters in diameter, thee particles of the material comprising a powder are less than about 250 μm in diameter, and/or the particles of the material comprising a powder are in a range of about 50 to 180 μm in diameter.

The providing a bone material, in some specific embodiments, comprises the steps of: providing at least one bone material; and generating a granular or granulated form of said material. The bone material may be an allograft material, a ceramic material, a metal, a polymer or a combination thereof. The method may also further comprise the step of adding at least one processing aid composition to the bone material, to the bone graft substitute, or to both. The processing aid composition is selected from the group consisting of stearic acid, calcium stearate, magnesium stearate, natural polymer, synthetic polymer, sugar and combinations thereof, in some embodiments. The natural polymer may be starch, gelatin, or a combination thereof; the synthetic polymer may be methylcellulose, sodium carboxymethylcellulose, or hydropropylmethylcellulose, or a combination thereof. In specific embodiments, the sugar is glucose. In embodiments wherein the bone material is a ceramic material, said ceramic material may comprise a calcium salt, or the ceramic material may be selected from the group consisting of calcium sulphate, alumina, silica, calcium carbonate, calcium phosphate, calcium tartarate, bioactive glass, zirconia, and a combination thereof. The calcium phosphate may be tricalcium phosphate or hydroxylapatite. The allograft bone material may be cortical-cancellous bone, demineralized bone matrix, or a mixture thereof, in some embodiments.

Methods of the present invention may further comprise the step of adding a biological agent to the bone material, to the bone graft substitute, or both. The biological agent is selected from the group consisting of a growth factor, an antibiotic, a strontium salt, a fluoride salt, a magnesium salt, a sodium salt, a bone morphogenetic factor, a chemotherapeutic agent, a pain killer, a bisphosphonate, a bone growth agent, an angiogenic factor, and a combination thereof. The growth factor is selected from the group consisting of platelet derived growth factor (PDGF), transforming growth factor β (TGF-β), insulin-related growth factor-I (IGF-I), insulin-related growth factor-II (IGF-II), fibroblast growth factor (FGF), beta-2-microglobulin (BDGF II), bone morphogenetic protein (BMP), and a combination thereof. The antibiotic is selected from the group consisting of tetracycline hydrochloride, vancomycin, cephalosporins, and aminoglycocides such as tobramycin, gentamicin, and a combination thereof. The bone morphogenetic factor is selected from the group consisting of proteins of demineralized bone, demineralized bone matrix (DBM), bone protein (BP), bone morphogenetic protein (BMP), osteonectin, osteocalcin, osteogenin, and a combination thereof.

The chemotherapeutic agent is selected from the group consisting of cisplatinum, ifosfamide, methotrexate, doxorubicin hydrochloride, and a combination thereof, in some embodiments. The pain killer is selected from the group consisting of lidocaine hydrochloride, bipivacaine hydrochloride, non-steroidal anti-inflammatory drugs such as ketorolac tromethamine, and a combination thereof, in some embodiments.

In specific embodiments, the bone graft substitute comprises a diameter of at least about 3 millimeters at its greatest width. In further specific embodiments, the bone graft substitute comprises a diameter of no more than about 4 millimeters at its greatest width.

Methods of the present invention may further comprise the step of sintering the bone graft substitute, in specific embodiments.

In another embodiment of the present invention, there is a method of manufacturing at least one shaped bone graft substitute comprising the steps of: providing at least one bone material; and subjecting the bone material to a press, wherein the press comprises: a shelf die comprising a configuration to impart at least a portion of the shape of the bone graft substitute; a lower punch positionable generally below the shelf die and comprising a configuration to impart at least a portion of the shape of the bone graft substitute; and an upper punch positionable generally above the shelf die, wherein following the subjecting step, a bone graft substitute having a substantially non-linear contour is manufactured.

In an additional embodiment of the present invention, there is a method of manufacturing a shaped bone graft substitute from a bone material, said method comprising the steps of: providing a stationary lower punch having a configuration to impart at least a portion of said shape upon said bone material; providing a shelf die having at least one cavity and positionable generally above the stationary lower punch, said cavity comprising a configuration to impart at least a portion of said shape upon said bone material, said lower punch positionable generally below the cavity of the shelf die; providing a moveable upper punch positionable generally above the cavity of the shelf die; introducing the bone material into the cavity; and moving the moveable upper punch to pressably contact the bone material in opposition to the stationary lower punch, whereby said steps form the bone material into the shaped bone graft substitute.

In another embodiment of the present invention, there is a method for manufacturing a shaped bone graft substitute, said method comprising the steps of: providing: a first punch having a first contact surface configured to effect a relief profile onto a surface of a bone material; a second punch having a second contact surface; and a shelf die having at least one cavity, said cavity comprising a surface configured to effect a relief profile onto a surface of the material; introducing the material into the cavity; positioning the shelf die generally in alignment with the first and second punches; and moving the second punch to pressably contact the material in the cavity to effect the desired relief profile on the surface of the material; whereby said moving step forms the material into the shaped bone graft substitute.

In specific embodiments, the steps of moving the second punch to pressably contact the material effects a substantially uniform distribution of pressure within said material.

In other specific embodiments, the punches are configured such that the shape of the bone graft substitute resulting from the method is a shape selected from the group consisting of a six-armed toy jack, a five-armed toy jack, a ring, or a combination thereof.

In additional specific embodimetns, the moving step applies a force to the material in a range of about 0.1 to about 5 tons, the moving step applies a force to the material in a range of about 0.2 to about 2 tons, and/or the moving step applies a force to the material in a range of about 0.1 to about 0.3 ton. In a specific embodiment, the bone material comprises a tricalcium phosphate powder.

In another embodiment of the present invention, there is a method of manufacturing a shaped bone graft substitute from a bone material, said method comprising the steps of: providing a first punch having a configuration to impart at least a portion of said shape upon said bone material; providing a shelf die having at least one cavity and positionable generally in alignment with the first punch, said cavity comprising a configuration to impart at least a portion of said shape upon said bone material; providing a second punch positionable generally in alignment with the cavity of the shelf die; introducing the bone material into the cavity; and pressably contacting the second punch to the bone material in opposition to the first punch, whereby said steps form the bone material into a bone graft substitute having a substantially non-linear contour shape. In a specific embodiment, the substantially non-linear contour shape is further defined as comprising a relief profile. In other specific embodiments, the first punch is stationary, the first punch is moveable, the die is stationary, or the die is moveable.

In another embodiment of the present invention, there is an apparatus for shaping a bone graft substitute from bone material, said apparatus comprising: a first punch having a top surface comprising a relief profile, said first punch positionable generally below a shelf die; a shelf die having at least one cavity and positionable generally above the first punch, wherein the contour of the wall of said cavity comprises a relief profile; and a moveable second punch opposable to the first punch. In a specific embodiment, the first punch is stationary. In another specific embodiment, the relief profile of the die cavity and the relief profile of the lower punch are substantially the same.

In an additional embodiment of the present invention, there is an apparatus for manufacturing a bone graft substitute from a bone material, said apparatus comprising: a first punch comprising a first contact surface having a profile configured to effect a relief profile onto a surface of the bone material; a second punch having a second contact surface, the second contact surface positioned in general alignment with the first contact surface; and a moveable die having at least one cavity, wherein the cavity comprises a surface configured to effect a relief profile onto a surface of the bone material, the moveable die being positionable generally in between the first and second punches.

In further specific embodiments, there is at least one bone graft substitute manufactured by a method or methods described herein.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIGS. 1A through 1E illustrate different pressing embodiments in the art. Figures are reproduced from Unkel (1998).

FIG. 2 is a powder compaction schematic with shelf-die assembly used to make, for example, a calcium phosphate toy jack shape. The die possesses at least part of the shape to be compacted to allow for a uniform density distribution for such an intricate shape, such as JAX® (Smith+Nephew, Inc.; Memphis, Term.).

FIGS. 3A and 3B illustrate the top openings of a shelf-die (3A, top panel) and a regular die (3B, top panel) for particular embodiments of the present invention, and cross-sections of the same dies are shown in the bottom panels.

FIG. 4 is an exemplary press configuration used to powder-compact six-armed toy jack shapes (left); shelf-die and punches are illustrated (right).

FIGS. 5A and 5B are a comparison of size between the 4 mm calcium phosphate and 6 mm calcium sulfate six-armed toy jack granules of U.S. Pat. No. 6,630,153. FIG. 5A shows a group of BGS granules, and FIG. 5B shows single granules.

FIG. 6 is a scanning electron microscopy (SEM) image of TCP Granules produced with P240R powder blend (top: 16×, middle: 65×, and bottom: 150×)—“north” side.

FIG. 7 is a SEM image of TCP Granules produced with P240R powder blend (top: 16×, middle: 65×, and bottom: 150×)—“south” side.

### DETAILED DESCRIPTION OF THE INVENTION

As used herein the specification, “a” or “an” may mean one or more. As used herein in the claim(s), when used in conjunction with the word “comprising”, the words “a” or “an” may mean one or more than one. As used herein “another” may mean at least a second or more.

The present invention is related in subject to the pending application Ser. No. 09/517,981, filed Mar. 3, 2000, and to U.S. Pat. No. 6,630,153, both of which are incorporated by reference herein in their entirety.

Definitions

The term “allograft bone material” as used herein is defined as bone tissue that is harvested from another individual of the same species. Allograft tissue may be used in its native state or modified to address the needs of a wide variety of orthopaedic procedures. The vast majority of allograft bone tissue is derived from deceased donors. Bone is about 70% mineral by weight, and the remaining 30% is collagen and non-collagenous proteins (including growth factors and bone morphogenic proteins, BMPs). Allograft bone that has been cleaned and prepared for grafting provides a support matrix to conduct bone growth, but is not able to release factors that induce the patient's biology to form bone cells and create new bone tissue. In a preferred embodiment, the allograft is cleaned, sanitized, and inactivated for pathogen (such as bacterial or viral) transmission.

The term “biological agent” as used herein is defined as an entity that is added to the bone graft substitute to effect a therapeutic end, such as facilitation and/or enhancement of bone ingrowth, facilitation and/or enhancement of bone healing, prevention of disease, administration of pain relief chemicals, administration of drugs, a combination thereof, and the like. Examples of biological agents include antibiotics, growth factors, fibrin, bone morphogenetic factors, bone growth agents, chemotherapeutics, pain killers, bisphosphonates, strontium salt, fluoride salt, magnesium salt, and sodium salt.

The term “bone graft substitute (BGS)” as used herein is defined as an entity for filling spaces in a bone tissue. In specific embodiments, the BGS as used herein is, for example, a jack, gel, putty, paste, formable strips, blocks, granules, chips, pellets, tablets, powder, or combination thereof. In a preferred embodiment, the BGS is a shaped particle, such as a non-tablet shape. In a more preferred embodiment, the shaped particle is a JAX® particle. In a preferred embodiment, the bone graft substitute is not ingested. In a specific embodiment, the particle comprises a relief profile. In a specific embodiment, the BGS comprises a shape useful for interlocking with another particle and/or bone.

The term “bone material” as used herein refers to any material that is desirable for applying to a bone. In a particular embodiment, the bone material is applied to a bone defect. The bone material may be granulated or granular in form. It may be allograft material, autograft material, demineralized bone matrix, a ceramic, a polymer, a metal, or a combination thereof.

The term “ceramic” as used herein is defined as any non-metallic, non-organic engineering material. An example of such a material is hydroxylapatite, calcium sulfate, alumina, silica, calcium carbonate, calcium phosphate (such as tricalcium phosphate), calcium tartarate, bioactive glass, zirconia, or combinations thereof.

The term “demineralized bone matrix” as used herein is defined as a bone material that has been treated for removal of minerals within the bone. Examples of demineralization processes known in the art include BioCleanse (Regeneration Technologies, Inc.) or D-MIN (Osteotech, Inc.). In a specific embodiment, the allograft material is subjected to a series of thermal (for example, freezing), irradiation, physical, aseptic, and/or chemical (for example, acid soak) processes known in the art. The latter (acid soak) typically consists of a proprietary permeation treatment to dissolve the minerals contained in the bone. This series of processes combines both demineralization and anti-viral activities, although each activity may be provided separately.

A skilled artisan recognizes that the actions of bone morphogenic proteins (BMPs) are inactivated by the mineral matrix of the bone. Demineralized bone matrix (DBM) is generated from a process that removes the mineral content and allows the bone morphogenic proteins to operate. In addition to removing bone mineral, the processes used to produce DBM also have viral-inactivating properties, providing an added assurance of safety for DBM products, in the respective embodiments.

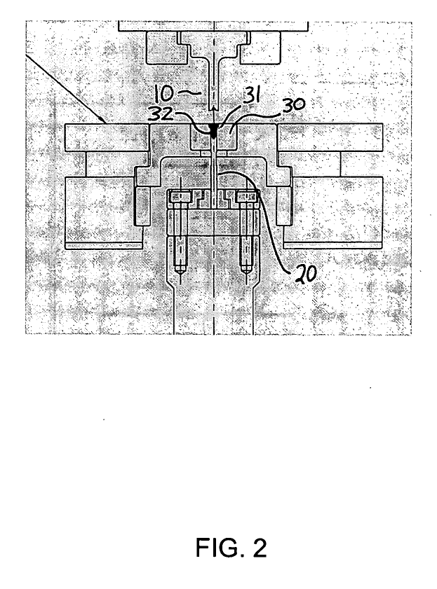

The term “die” as used herein is defined as a tool for imparting a desired shape or form to a material. In a specific embodiment, the die is moveable, although in an alternative embodiment the die is stationary. In a specific embodiment, the die has at least one cavity, and in some embodiments the cavity has a constant cross-section, and in some embodiments the cross-section is non-circular. In another preferred embodiment, the shape of the cavity of the die is a desired shape that would impart that shape upon a bone material during manufacturing of the desired bone graft substitute to bear the shape. Furthermore, in a specific embodiment, the die facilitates entry of a punch that has an end configured to also impart the desired shape onto a material, and thus may be considered an open die. A skilled artisan recognizes that in an embodiment (as shown in the exemplary FIG. 2) having a shelf-die 30, a first punch 10 can transverse through the die cavity, but a second punch 20 cannot, as it is stopped by the “shelf” 31. In specific embodiments, the first punch 10 is referred to as the lower punch, which can transverse through the die cavity 32, but the second punch 20, referred to as the top punch, cannot as it is stopped by the “shelf” 31. A shelf die does not have a constant cavity cross-section throughout its length perpendicular to the pressing axis (not a straight cylinder). The upper part of the die cavity is typically larger than the lower part.

The term “granulated particles” refers to particles that may be composed of agglomerates of smaller particles through a granulation process, using a spray-drying or fluid-bed granulation technique known in the art, or, alternatively, they may be dispersed solid particles in granular form produced by milling, crushing, or grinding larger particles or blocks. The particles may be referred to as grains, granules, powder, and the like. The particles are preferably comprised of a substance or substances that are amenable for bone growth, bone repair, bone augmentation, and the like. In a specific embodiment, the manufacture of the bone graft substitutes of the present invention comprises the use of a processing aid composition and, in some the embodiments, the material of which the particles are manufactured from and/or the granulated particles themselves comprise the processing aid composition. In a specific embodiment, the material from which the particles are manufactured is primarily comprised of finely dispersed solid particles. In another specific embodiment, one must view the particles under a microscope to differentiate one particle from another. In a preferred embodiment, it is not a chip. In a specific embodiment, at least the majority of the particles in the mixture are less than about 10 mm in diameter. In a more preferred embodiment, the majority of particles in the mixture are less than about 250 microns in diameter. In a most preferred embodiment, the majority of the particles in the mixture are between about 50 and about 180 microns in diameter. In a preferred embodiment, the powder comprises 75 micron-125 micron powder particles.

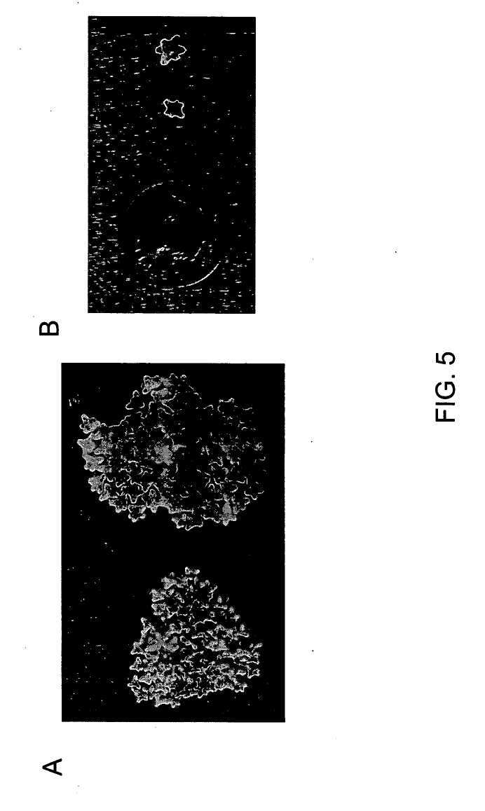

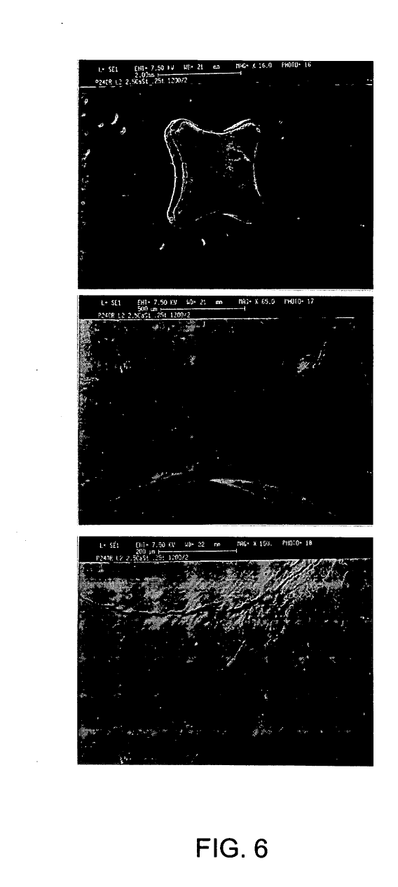

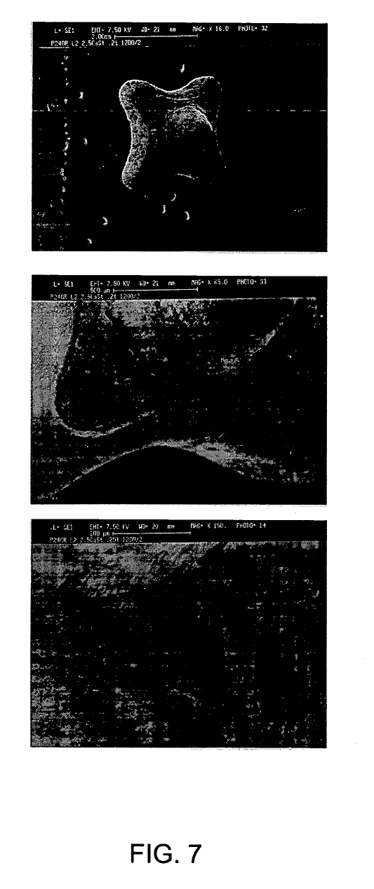

The term “jack” as used herein is defined as a small object with six arms, such as is illustrated in the exemplary FIG. 5. In a specific embodiment, the shape is similar to a toy jack such as is used in modern times in the U.S. in the game of jacks. However, in an alternative embodiment, the jack has five arms. In a specific embodiment, the jack looks substantially like that of FIG. 5. In a specific embodiment, it is a three-dimensional six-armed star shape.

The term “JAX®” as used herein is defined as a bone graft substitute particle which generally has the shape of the particle of the exemplary FIG. 5. In a specific embodiment, it is a three-dimensional six-armed star shape. In a specific embodiment, there is a shaped particle comprising a center portion and at least four tapered extremities projecting from said center portion wherein said projections provide for interstitial spaces between adjacent extremities, each extremity having a base attached at said center portion, an opposite point, a length, and a circular transverse cross-sectional configuration, wherein said interstitial spaces of one said particle will accept at least one extremity of an adjacent said particle to facilitate interlocking of adjacent particles. In a further specific embodiment, the circular cross-section of the extremities, or arms, of the shaped particle of the invention is beneficial for strength purposes, because an equivalent response to loading will occur regardless of the application of the load around the circumference. In contrast, an oval shape as is utilized in commercially available products and in U.S. Pat. No. 5,676,700 has reduced resistance to loading when the loading is applied in the direction of the axis of the shorter width of the oval compared to the axis of the longer width of the oval.

The term “first punch” as used herein is defined as a punch which is capable of moving through a die cavity, such as substantially completely through the die cavity or at least until meeting the force of bone material and an opposing punch. The movement of the first punch is not stopped by the shelf of a shelf die. An exemplary embodiment is illustrated in FIG. 2 at number 10. In an exemplary embodiment, the first punch is further defined as being a “lower punch” 10 positioned generally below a die 30 of the present invention. In a specific embodiment, the surface of one end of the first punch 10 comprises a non-flat surface. In another specific embodiment, the plane of the surface of one end of the lower punch 10 is not entirely perpendicular to the length of the punch. In a further specific embodiment, the punch is stationary, although in an alternative embodiment the punch is moveable. In specific embodiments, the lower punch 10 imparts a shape upon a bone material. In further specific embodiments, the lower punch 10 imparts a non-flat surface onto a bone material.

The term “powder compaction” as used herein is defined as the process wherein a bone material, which may be synthetic or derived from natural bone, comprising granulated particles or granular in form, such as a powder, is compressed into a desired shape. In a preferred embodiment, the powder is tricalcium phosphate, demineralized bone matrix, or a mixture thereof. In another preferred embodiment, the powder particles are less than about 10 mm, more preferably less than about 250 μm, even more preferably between about 50 and 180 microns, and most preferably between about 75 and 125 microns in diameter.

The term “pressably contact” as used herein is defined as the touching of a material using pressure upon the material. In a specific embodiment, pressably contacting the material results in compaction of the material, such as in compaction of a bone material, for example, a powder.

The term “processing aid composition” as used herein is defined as a composition utilized for facilitating compaction of a powder and/or release of a compacted powdered product from a die. Specific examples include stearic acid, magnesium stearate, calcium stearate, natural polymer, synthetic polymer, sugar and combinations thereof. In a specific embodiment, the natural polymer is starch, gelatin, or combinations thereof. In another specific embodiment, the synthetic polymer is methylcellulose, sodium carboxymethylcellulose, or hydropropylmethylcellulose. In an additional specific embodiment, the sugar is glucose. In a further specific embodiment, the processing aid composition is glycerol.

The term “pulverize” as used herein is defined as grind, granulate, crush, mash, chop up, or pound a starting material into smaller constituents. In a specific embodiment, the starting material is reduced to powder or dust.

The term “punch” as used herein is defined as an apparatus in the form of a rod, such as comprised of metal or ceramic, that is sharp-edged and variously shaped at one end for imparting a desired shape or form to a material. In a preferred embodiment, the shape imparts a six-armed star shape, such as the exemplary shape in FIG. 2. In specific embodiments, the punch is solid or hollow. In a specific embodiment, the shape of the punch imparts a shape for interlocking with another particle and/or bone.

The term “relief profile” as used herein is defined as a contour on a material having projections and indentations which approximate the contour of the surface that imparts the contour, such as a punch, a die cavity, or both. In a specific embodiment, the shape of the relief profile imparts a shape for interlocking with another particle and/or bone. In another specific embodiment, the relief profile comprises a substantially non-linear contour.

The term “substantially uniform distribution of pressure” as used herein is defined as an amount of pressure upon a material that is generally consistent in quantity over the surface of the material.

The term “three-dimensional intricate shape” as used herein is defined as a shape having indentations and/or projections and/or at least one surface that has a relief profile. In a specific embodiment, the shape of the three-dimensional intricate shape is one for interlocking with another particle and/or bone. In particular embodiments, the shape of the bone graft substitute has a substantially non-linear contour.

The term “second punch” as used herein refers to a moveable punch moveable into a die cavity but whose movement is impeded by the shelf of a shelf die. The term “second punch” as used herein may be further defined as an “upper punch” which is a moveable punch positioned generally above a die. In some embodiments, the surface of one end of the punch is not flat. In a specific embodiment, the second punch is configured to impart a relief profile upon a bone material, such as the plane of the surface of one end of the second punch not being entirely perpendicular to the length of the punch. In another embodiment, the surface of the end of the second punch imparts a shape having indentations and/or projections upon a bone material.

The term “withdrawal press” as used herein is defined as a powder compaction press using withdrawal of the die rather than an upper motion of a lower punch for ejection of the product.

The Present Invention

This process is an improvement upon U.S. Pat. No. 6,630,153, incorporated by reference herein in its entirety. Whereas U.S. Pat. No. 6,630,153 describes manufacture of bone graft substitutes, preferably about 6 mm at their greatest width, using a process that requires the use of two lower punches, a cylindrical die and an upper punch, the present invention comprises a different configuration, which may be better-suited to manufacture bone graft substitutes of sizes smaller than about 4 mm.

In a specific embodiment, the bone graft substitute comprises a shape having a non-smooth contour, wherein the term contour refers to the outline of the particle. The bone graft substitute may be referred to as having a substantially non-linear contour. In particular embodiments, the contour may be referred to as irregular, having projections and/or indentations, or not straight. The contour may also be referred to as having a relief profile.

The present invention supplies a long-sought solution in the art, described above, by making BGS products or granules by powder compaction to provide a scaffold structure for ingrowth from the host bone and for the purpose of easy delivery. In a specific embodiment, the shape of the product provides for interlocking with at least one other BGS particle and/or bone.

This invention is directed to similar but nonidentical technology described in U.S. Pat. No. 6,630,153, incorporated by reference herein in its entirety. U.S. Pat. No. 6,630,153 describes the use of two lower punches in order to manufacture an intricate 3-D shape, such as a six-armed toy jack (JAX®) shape. These granules (comprised of, for example, calcium sulfate) are about 6 mm wide in its largest dimension. Smaller granules are desirable, in some embodiments, such as about 4 mm in their largest dimension. Manufacture of such a small-sized particle by methods described in U.S. Pat. No. 6,630,153, though achievable, may be sub-optimal given the strength limits of the lower inner punch used for the larger sized granules. Thus, the dual lower punch configuration of U.S. Pat. No. 6,630,153 may not be optimal to powder compact smaller granules. An improved design for the punches and a new tooling configuration are desirable to manufacture particles with less than about 6 mm at its greatest dimension.

The present invention is an improvement over presently available products and methods by taking, in a specific embodiment, a powder, as opposed to a chip, and manufacturing a shape from the powder, wherein the shape is used for a bone graft substitute. An embodiment of the present invention is to manufacture a BGS shape by compressing or compacting material comprising a powder, powders, or mixture of powders. More specifically, the process comprises powder compaction, which is a process used primarily in metal and ceramic powder processing, such as by using tricalcium phosphate. Another object of the present invention is to use powder compaction to manufacture an allograft (human bone, DBM) BGS shape. An additional object of the present invention is to utilize powder compaction to produce a synthetic or ceramic (such as calcium sulfate or calcium phosphate) BGS shape. An additional object of the present invention is to use powder compaction to produce an allograft/synthetic or ceramic composite BGS shape.

Another object of the present invention is to use powder compaction to produce an allograft, synthetic or ceramic bone graft substitute shape comprising bioactive agents (such as antibiotic, proteins, growth factors, BMPs, acids, angiogenic agents and the like), wherein the powder compaction utilizes methods and compositions described herein.

An additional object of the present invention is to use a processing aid (such as, for example, stearic acid, magnesium stearate, calcium stearate) or a mix of two or more of these processing aids to produce a shape having a desirable relief profile and/or a shape capable of interlocking with another particle and/or bone, such as a six-armed toy jack shape, a five-armed toy jack shape, or other shapes known in the art.

The methods and compositions described herein utilize both a shelf die and punch each of which comprises a shape that will impart a desirable relief profile upon bone material delivered to the system to manufacture the bone graft substitute. In specific embodiments, at least one cavity of the die has a constantly shaped cross-section, although the size of the cross-section may change. In specific embodiments, the cross-section of a cavity of the die is non-circular.

The bone material of the present invention from which the bone graft substitutes are manufactured may be any material suitable for administration to, in, and/or around bone. In one embodiment of the present invention, the material comprises calcium phosphate, and, more specifically, tricalcium-phosphate, although it may also or alternatively comprise, for example, allograft material, autograft material, DBM, ceramic material, such as calcium sulfate, a polymer, a metal, other synthetic or bone-derived materials, or a combination thereof. In the embodiments wherein metal is used, preferably a biocompatible metal, the material may be titanium, titanium alloy, zirconium, zirconium alloy, stainless steel, cobalt-based alloy, chromium alloy, molybdenum alloy, tantalum, tantalum alloy, riobium, or a combination thereof. In the embodiments wherein allograft material is used, the allograft material may be processed, such as subjected to a demineralization process, or it may be unprocessed, in which minerals remain intact. The material in any case is preferably cleaned, sanitized, and inactivated for pathogen transmission, such as a virus. The allograft material may be of cortical-cancellous bone or demineralized bone matrix.

In a specific embodiment of the present invention, the bone material is ceramic, such as a calcium salt; calcium sulfate, hydroxylapatite, a calcium phosphate; bioactive glass, zirconia, a vitreous based glass (such as may be used for maxio-cranio applications); calcium carbonate, a calcium based mineral; various calcium phosphates, and calcium-rich minerals, including tricalcium phosphate and orthophosphate; apatite/wollastonite glass ceramic, a calcium silicate often used in bone spacer applications; resorbable polymers such as polysaccharides, polyglycolates, polylactic acid (PLA), polyglycolic acid (PGA), polycaprolactone, polypropylene fumarate (all of which can be blended or made to co-polymers to control the desired properties of the product); and composites of resorbable polymers and glass or ceramic fillers. Bioactive glass is a material whose major components are CaO, SiO₂ and P₂O₅ and whose minor components may be Na₂O, MgO, Al₂O₃, B₂O₃ and CaF₂.

The new design useful for manufacturing substitutes that are about 4 mm or smaller (but in preferred embodiments is greater than about 3 mm) comprises a shelf-die, one lower punch and one upper punch. The shelf-die is designed to comprise part of the shape of the granule. In a specific embodiment, an inner surface of at least one cavity of a shelf die comprises a relief profile that imparts at least a portion of a desired shape upon a bone material to generate the bone graft substitute, although the relief profile of the inner surface of the cavity may not carry throughout the entire cavity. In similar embodiments, the top surface of the lower inner punch is also shaped to impart at least a portion of the shape of the granule. In this configuration, the lower inner punch may be designed with dimension large enough to withstand the compaction loads required to manufacture the smaller granules.

In the present invention, a powder compaction process is used to produce a bone graft substitute, such as an exemplary small-sized six-armed product as illustrated in FIG. 5, such as a three-dimensional six-armed star shape, made of, for example, calcium phosphate, more specifically tricalcium phosphate (Ca₃(PO₄)₂). The same process could be used to produce a bone graft substitute of any shape made of DBM or bone material. Processing aids, for example calcium stearate or magnesium stearate, are added to allow compaction of the powders and/or release of the product from the die. In a specific embodiment, the TCP bone graft substitutes have slower resorption times than calcium sulfate BGS, because TCP materials resorb through chemical dissolution and cell-mediated processes, whereas calcium sulfate BGS dissolve through chemical dissolution only (Bauer and Smith, 2002).

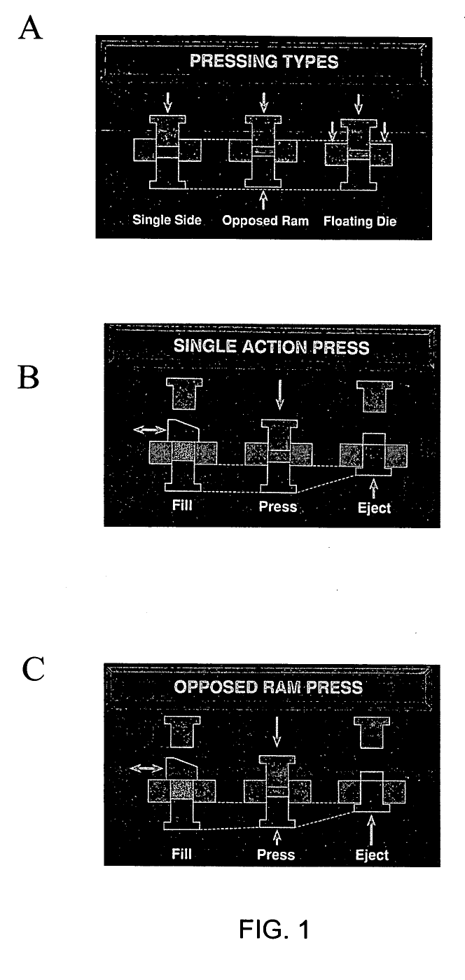

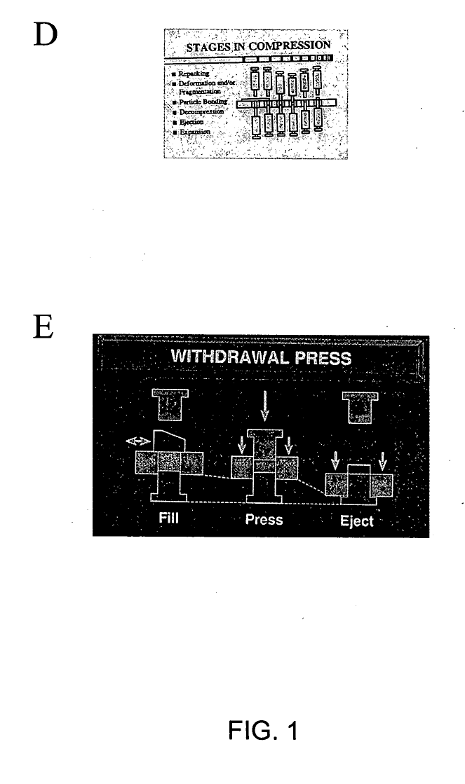

The powder compaction process is unique to produce bone graft substitutes and bone void fillers, particularly those comprising projections and/or indentations, including those that would interlock with another similar or identical particle. Previous BGS products having a tablet shape have been produced using a tableting process. Tablet processing consists of a simple pressing action with a lower punch pressing the powder blend against a stationary, or sometimes translating, upper punch through a stationary die (FIG. 1A). Tableting typically utilizes a tableting press. In some embodiments, tableting does not allow for a uniform distribution of pressures within the granules and therefore does not allow for the production of intricate shapes, such as an exemplary small-sized six-armed product as illustrated in FIG. 5, or a three-dimensional six-armed star shape.

Powder compaction is an advanced manufacturing process that allows for a uniform distribution of pressures during compaction, therefore allowing for the production of intricate shapes. Although traditionally powder compaction has utilized a withdrawal press, it is an embodiment of the present invention to use not only a withdrawal press but alternatively another kind of press, such as an single action press or an opposed ram press.

FIGS. 1A through 1E illustrate various types of pressing means in the art, including pressing by single side press (also referred to as a single action press), an opposed ram press, and a withdrawal press (which, in some embodiments comprises a floating (i.e. moveable) die). In a single action press, a stationary die having a moveable lower punch is filled, which is followed by pressing from above with a moveable upper punch. The lower punch moves upward only to eject the product. In an opposed ram press, a stationary die has moveable upper and lower punches stationed generally above the hole in the die, which is filled, and this is followed with pressing action from above and below using the upper and lower punches, respectively. The product is ejected upon expulsion with the lower die transversing upward. In a withdrawal press, a moveable die is filled, a moveable upper punch presses the material, and the moveable die shifts downward to eject the product.

In the embodiment utilizing powder compaction with a withdrawal press, specific tooling is required that allows several relative translations between one or several punches or dies to distribute the compaction pressures. In some embodiments for powder compaction using a withdrawal press, the upper punch, lower outer punch and die are translating; the lower inner punch is stationary but because of the relative motion of the punches and die, the pressure is evenly distributed within the powder compacted part.

In accordance with the present invention, the interrelated designs of the die and lower punch are based on the compression behavior of the powder. An exemplary schematic of the novel tool design is shown in FIG. 2, including a one-piece upper punch (10), one-piece lower punch (20), and a floating shelf-die (30).

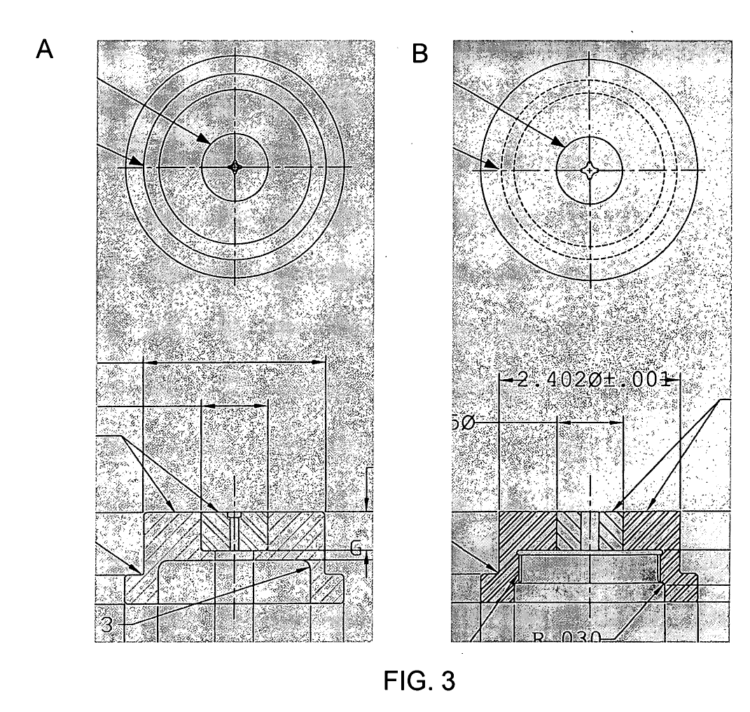

In particular embodiments, FIGS. 3A and 3B illustrate cross-sections of dies. In the top illustration of FIG. 3A, there is a shelf-die comprising a shaped opening having a non-circular cross-section that assists in imparting a shape onto a bone material being pressed. In some embodiments, the first punch pressing from the bottom also has a shape on the surface that compresses the bone material which imparts a shape onto the bone material. In preferred embodiments, the shape generated by this tooling is not a tablet but rather is a three-dimensional intricate shape, such as one comprising a relief profile and/or one having a substantially non-linear contour. The shape preferably comprises projections and/or indentations.

As illustrated in the bottom illustration in FIG. 3A, the cross-section throughout the shelf die varies from top to bottom. In a non-limiting embodiment, the upper portion of the open cavity of the shelf die is greater in width than the lower portion. In a specific embodiment, the width of the upper portion of the open cavity is approximately equal to the width of the upper punch, and the width of the lower portion of the cavity is approximately equal to the width of the lower punch. In certain aspects of the invention, the movement of the upper punch into the cavity is prohibited beyond the point of the shelf. The design of the shelf-die is unique to the compaction properties of the powders composing the blend, in specific embodiments. A skilled artisan recognizes that different designs may be required for various powder materials.

In FIG. 3B, there is a regular die utilized for larger particles such as are generated by methods described in U.S. Pat. No. 6,630,153. A skilled artisan recognizes that the shape illustrated in FIGS. 3A and 3B is not limiting and that other shapes would apply for any cross-sectional shape beside a “star” shape. The top views of the shelf die could include any shape (circle, lozenge, square, oval, or asymmetric shape).

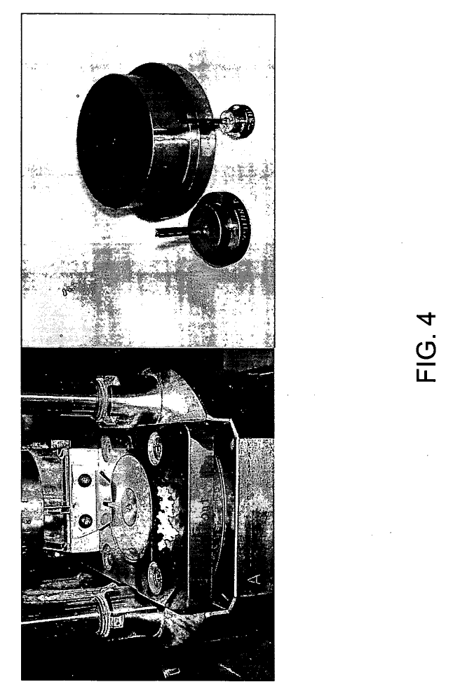

As described in the Examples herein, a powder compaction press (withdrawal type) was used to compress tricalcium phosphate powder blends. Granulated tricalcium phosphate powder was blended with approximately 11 wt. % processing aids (10 wt % stearic acid and 1% magnesium stearate). Special tooling had been made to allow uniform distribution of compressive forces during the compaction process. The floating shelf-die and surrounding machine configuration is provided in FIG. 4. A compression force between 0.3 and 0.6 tons was used to make 4 mm JAX® granules (FIG. 4). These granules may be subsequently sintered at high temperature (900-1400° C.).

A processing aid, or a blend of two or more processing aids (magnesium stearate and stearic acid), may optionally be used in the compaction process. In some embodiments, processing aids include calcium stearate, stearic acid and magnesium stearate. Other processing aids could also be used, such as calcium stearate, starch, and so forth. Other blends including other synthetic or ceramic, allograft (human bone, such as DBM), or bioactive agents (such as antibiotics, growth factors, proteins, BMPs, acids), individually or as a mix of two or more of the aforementioned components can potentially be compacted to produce a shape, such as a JAX® shape. In a particular embodiment of the present invention, a porous BGS is manufactured with a method or methods described herein. In specific embodiments, this is achieved by adding to a bone material a processing aid, a foaming agent, or both, followed by burning off the processing aid and/or foaming agent with a low temperature, leaving behind it pores. Exemplary foaming agents include a polymer, such as a spherical polymer, starch, naphthalen, and the like. A skilled artisan recognizes that the amount of porosity achieved within the particle itself is determined by the application, at least in part, and that the amount of processing aid and/or foaming agent may be in the range of about 0-90%.

A skilled artisan recognizes that a method of manufacturing BGS may optionally require a sintering step in the process, depending on the material from which the BGS is generated. For example, calcium sulfate particles should not require a sintering step, whereas calcium phosphate particles, calcium carbonate particles, alumina particles, silica particles, tartarate particles, and metals may require a sintering step, in some embodiments. A skilled artisan also recognizes that in the embodiments wherein a sintering step is utilized, the temperature selected for the step is dependent upon a variety of factors well-known in the art, such as a particle dissolution rate, the presence or absence of a processing aid, and/or the like. In a specific embodiment, the sintering step has a temperature from at least about 700° C. As an exemplary discussion only, one may sinter a material at about 1200° C. for a particular particle dissolution rate but prefer a lower temperature, such as about 900° C. for a faster particle dissolution rate. A skilled artisan recognizes that, for example, when a particular particle dissolution rate is desired, this may be tested for, such as by subjecting a particle in vitro to an acidic solution and measuring the weight loss as a function of time.

The sintering cycle may also be varied according to the presence of a particular processing aid. In a particular embodiment, a material is subjecting to certain temperature and time to achieve burning off of the processing aid, such as less than 700° C. Some materials require higher temperature and/or durations of temperature exposure, whereas other materials do not require such parameters, and a skilled artisan recognizes how to determine this.

In a specific embodiment of the present invention, the bone graft substitute is manufactured with a biological agent, either within the substitute particle, coated on the surface of the particle, or both.

In a specific embodiment, the bone material of the present invention is colored to make it more visible. In another specific embodiment, differently shaped BGS of the present invention are denoted with different colors for better differentiation of the particles. In another specific embodiment, the particles are coated or have contained within them an agent such as green fluorescent protein, blue fluorescent protein, or luciferase to make them more visible.

It is an object of the present invention to provide apparatus and methods to manufacture a bone graft substitute through powder compaction of a bone material powder into a shape. Although the bone material powder may be an allograft material, a synthetic material, a ceramic material, a polymer material, or a combination thereof, it is preferably tricalcium phosphate, demineralized bone matrix, or a combination thereof. The shape is preferably one that will provide strength to the bone graft and allow bone ingrowth from the host bone. A preferred shape is the exemplary small-sized six-armed product as illustrated in FIG. 5, a three-dimensional six-armed star shape, and the like.

The method of manufacturing the BGS preferably includes compressing, compacting, pressably contacting, packing, squeezing, tamping, or squashing a bone material powder into the desired shape. The method preferably utilizes powder compaction, which a skilled artisan recognizes is a process well known in metal and ceramic powder processing. A processing aid composition is preferably utilized to facilitate compaction of the material and release of the product from the die.

In one embodiment of the present invention, the method includes obtaining a bone material, such as from a donor, cadaver, and the like, pulverizing the material to produce a bone material powder, which a skilled artisan recognizes is preferably to a consistency that is conducive to compaction and generation of a product that is substantially non-friable. The particles are preferably substantially homogeneous in size. The powder is then subjected to a powder compaction process.

The powder compaction process may utilize a withdrawal press. The withdrawal press may comprise a lower punch, an upper punch, and a moveable die. A skilled artisan also recognizes the press will comprise other parts standard in the art, such as a means to fill a die cavity with the powder, and so on.

The die is preferably moveable, although it may be stationary, and is generally located, during processing, between the lower and upper punches. It is preferably in alignment with at least one of a lower and upper punch. The die preferably has at least one cavity, and also preferably is shaped corresponding to the desired generated shape of the particle and to permit the corresponding punches to fit in the cavity.

The surfaces of the punches that contact the powder material are preferably configured with a contour or shape that imparts the desired shape onto the powder upon contact with the material. The shape may be the exemplary small-sized six-armed product as illustrated in FIG. 5 or any shape that provides for interlocking with another particle and/or bone. In an alternative embodiment, the shape is a tablet, a strip, a block, a cube, a pellet, a pill, a lozenge, a sphere, or a ring. The shape of the punches may be that which will impart a jack shape, such as is demonstrated in FIG. 5. The shape is preferably a jack such as a JAX® particle. In one embodiment of the present invention, one of the punches may impart a jack shape and the other punch may have a generally flat surface, although the resulting product will still result in a jack shape.

In the process, the moveable die and punches are provided. The powder is introduced into a cavity in the die and the die is positioned generally in alignment with at least one of the punches. In a preferred embodiment, the die is positioned generally above the stationary lower punch. In a specific embodiment, a moveable upper punch pressably contacts the powder toward the stationary lower punch. The step of moving the upper punch preferably effects a substantially uniform distribution of pressure within the bone material. The uniformity of the pressure distribution across the surface of the bone material is desirable because it is the best way to ensure that the resulting product is structurally sound. The moving step thus forms the bone material into the desired shaped BGS.

The moving steps preferably apply a force in the range of about 0.1 to about 5 tons, more preferably about 0.1 to about 2 tons, and most preferably about 0.2 to about 0.5 ton. The force may be greater, and a skilled artisan recognizes that the upper limit is determined by the critical density of the powder.

Thus, in an embodiment of the present invention, there is a method of manufacturing at least one shaped bone graft substitute by providing a bone material and subjecting it to a press having, at least, a first punch with a configuration to impart at least a portion of the shape of the bone graft substitute to the bone material; a shelf die containing at least one cavity for receiving at least one punch, wherein the cavity comprises a shelf; a configuration to impart at least a portion of the shape of the bone graft substitute; and a configuration concentrically surroundable to the first punch and moveable axially thereabout; and a second punch, wherein the second punch is moveable into a part of the cavity, the part bounded by the shelf of the shelf die, wherein the second punch is opposable to the first punch, and wherein following the subjecting step a bone graft substitute having a substantially non-linear contour is manufactured. In a specific embodiment, the bone material comprises a powder. In another specific embodiment, the particles of the material comprising a powder are less than about 10 millimeters in diameter, thee particles of the material comprising a powder are less than about 250 μm in diameter, and/or the particles of the material comprising a powder are in a range of about 50 to 180 μm in diameter.

The step of providing a bone material, in some specific embodiments, comprises the steps of: providing at least one bone material; and generating a granular or granulated form of the material. The bone material may be an allograft material, a ceramic material, a metal, a polymer or a combination thereof. The method may also further comprise the step of adding at least one processing aid composition to the bone material, to the bone graft substitute, or to both. The processing aid composition is selected from the group consisting of stearic acid, calcium stearate, magnesium stearate, natural polymer, synthetic polymer, sugar and combinations thereof, in some embodiments. The natural polymer may be starch, gelatin, or a combination thereof; the synthetic polymer may be methylcellulose, sodium carboxymethylcellulose, or hydropropylmethylcellulose, or a combination thereof. In specific embodiments, the sugar is glucose. In embodiments wherein the bone material is a ceramic material, said ceramic material may comprise a calcium salt, or the ceramic material may be selected from the group consisting of calcium sulphate, alumina, silica, calcium carbonate, calcium phosphate, calcium tartarate, bioactive glass, zirconia, and a combination thereof. The calcium phosphate may be tricalcium phosphate or hydroxylapatite. The allograft bone material may be cortical-cancellous bone, demineralized bone matrix, or a mixture thereof, in some embodiments.

Methods of the present invention may further comprise the step of adding a biological agent to the bone material, to the bone graft substitute, or both. The biological agent is selected from the group consisting of a growth factor, an antibiotic, a strontium salt, a fluoride salt, a magnesium salt, a sodium salt, a bone morphogenetic factor, a chemotherapeutic agent, a pain killer, a bisphosphonate, a bone growth agent, an angiogenic factor, and a combination thereof. The growth factor is selected from the group consisting of platelet derived growth factor (PDGF), transforming growth factor β (TGF-β), insulin-related growth factor-I (IGF-I), insulin-related growth factor-II (IGF-II), fibroblast growth factor (FGF), beta-2-microglobulin (BDGF II), bone morphogenetic protein (BMP), and a combination thereof. The antibiotic is selected from the group consisting of tetracycline hydrochloride, vancomycin, cephalosporins, and aminoglycocides such as tobramycin, gentamicin, and a combination thereof. The bone morphogenetic factor is selected from the group consisting of proteins of demineralized bone, demineralized bone matrix (DBM), bone protein (BP), bone morphogenetic protein (BMP), osteonectin, osteocalcin, osteogenin, and a combination thereof.

The chemotherapeutic agent is selected from the group consisting of cisplatinum, ifosfamide, methotrexate, doxorubicin hydrochloride, and a combination thereof, in some embodiments. The pain killer is selected from the group consisting of lidocaine hydrochloride, bipivacaine hydrochloride, non-steroidal anti-inflammatory drugs such as ketorolac tromethamine, and a combination thereof, in some embodiments.

In specific embodiments, the bone graft substitute comprises a diameter of at least about 3 millimeters at its greatest width. In further specific embodiments, the bone graft substitute comprises a diameter of no more than about 4 millimeters at its greatest width.

Methods of the present invention may further comprise the step of sintering the bone graft substitute, in specific embodiments. In another embodiment of the present invention, there is a method of manufacturing at least one shaped bone graft substitute comprising the steps of: providing at least one bone material; and subjecting the bone material to a press, wherein the press comprises: a shelf die comprising a configuration to impart at least a portion of the shape of the bone graft substitute; a lower punch positionable generally below the shelf die and comprising a configuration to impart at least a portion of the shape of the bone graft substitute; and an upper punch positionable generally above the shelf die, wherein following the subjecting step, a bone graft substitute having a substantially non-linear contour is manufactured.

In an additional embodiment of the present invention, there is a method of manufacturing a shaped bone graft substitute from a bone material, the method comprising the steps of: providing a stationary lower punch having a configuration to impart at least a portion of said shape upon said bone material; providing a shelf die having at least one cavity and positionable generally above the stationary lower punch, said cavity comprising a configuration to impart at least a portion of said shape upon said bone material, said lower punch positionable generally below the cavity of the shelf die; providing a moveable upper punch positionable generally above the cavity of the shelf die; introducing the bone material into the cavity; and moving the moveable upper punch to pressably contact the bone material in opposition to the stationary lower punch, whereby said steps form the bone material into the shaped bone graft substitute.

In another embodiment of the present invention, there is a method for manufacturing a shaped bone graft substitute, said method comprising the steps of: providing: a first punch having a first contact surface configured to effect a relief profile onto a surface of a bone material; a second punch having a second contact surface; and a shelf die having at least one cavity, said cavity comprising a surface configured to effect a relief profile onto a surface of the material; introducing the material into the cavity; positioning the shelf die generally in alignment with the first and second punches; and moving the second punch to pressably contact the material in the cavity to effect the desired relief profile on the surface of the material; whereby said moving step forms the material into the shaped bone graft substitute.

In specific embodiments, the steps of moving the second punch to pressably contact the material effects a substantially uniform distribution of pressure within said material.

In other specific embodiments, the punches are configured such that the shape of the bone graft substitute resulting from the method is a shape selected from the group consisting of a six-armed toy jack, a five-armed toy jack, a ring, or a combination thereof.

In additional specific embodimetns, the moving step applies a force to the material in a range of about 0.1 to about 5 tons, the moving step applies a force to the material in a range of about 0.2 to about 2 tons, and/or the moving step applies a force to the material in a range of about 0.1 to about 0.3 ton. In a specific embodiment, the bone material comprises a tricalcium phosphate powder.

In another embodiment of the present invention, there is a method of manufacturing a shaped bone graft substitute from a bone material, said method comprising the steps of: providing a first punch having a configuration to impart at least a portion of said shape upon said bone material; providing a shelf die having at least one cavity and positionable generally in alignment with the first punch, said cavity comprising a configuration to impart at least a portion of said shape upon said bone material; providing a second punch positionable generally in alignment with the cavity of the shelf die; introducing the bone material into the cavity; and pressably contacting the second punch to the bone material in opposition to the first punch, whereby said steps form the bone material into a bone graft substitute having a substantially non-linear contour shape. In a specific embodiment, the substantially non-linear contour shape is further defined as comprising a relief profile. In other specific embodiments, the first punch is stationary, the first punch is moveable, the die is stationary, or the die is moveable.

In another embodiment of the present invention, there is an apparatus for shaping a bone graft substitute from bone material, said apparatus comprising: a first punch having a top surface comprising a relief profile, said first punch positionable generally below a shelf die; a shelf die having at least one cavity and positionable generally above the first punch, wherein the contour of the wall of said cavity comprises a relief profile; and a moveable second punch opposable to the first punch. In a specific embodiment, the first punch is stationary. In another specific embodiment, the relief profile of the die cavity and the relief profile of the lower punch are substantially the same.

In an additional embodiment of the present invention, there is an apparatus for manufacturing a bone graft substitute from a bone material, said apparatus comprising: a first punch comprising a first contact surface having a profile configured to effect a relief profile onto a surface of the bone material; a second punch having a second contact surface, the second contact surface positioned in general alignment with the first contact surface; and a moveable die having at least one cavity, wherein the cavity comprises a surface configured to effect a relief profile onto a surface of the bone material, the moveable die being positionable generally in between the first and second punches.

In further specific embodiments, there is at least one bone graft substitute manufactured by a method or methods described herein.

The contact surface area of the first punch is generally equivalent to a contact surface area of the second punch such that the moving step applies a substantially uniform pressure distribution to the bone material.

The lower punch moves so that its edges meet the edges of the shelf-die (or the shelf-die moves with a stationary punch). In the press position, the lower punch edges matches the edges of the shelf of the shelf die so that the pair produce a continuous surface as would be observed with single punch.

In another embodiment of the present invention, there is an apparatus for manufacturing a bone graft substitute from a bone material powder wherein the apparatus comprises a first punch having a first contact surface having a profile configured to effect a relief profile onto a surface of the bone material; a second punch having a second contact surface, the second contact surface positioned in general alignment with the first contact surface; and a moveable die having at least one cavity configured to effect a relief profile onto a surface of the bone material, the moveable die being positionable generally in between the first and second punches.

In a specific embodiment of the present invention, the methods for manufacture of the bone graft substitute substantially lack administration of liquid, such as aqueous liquid, to the bone material during the process. Furthermore, the compositions of the present invention substantially lack moisture, such as water. In particular embodiments, no water is added to the powder during the manufacturing process, although a skilled artisan recognizes that there may be moisture inherently in the material from which the BGS is made. For example, a calcium sulfate powder may be about 10% water, in some embodiments. In other embodiments a calcium phosphate powder may be about 2%-4% water.

It is preferable for the bone graft substitute embodiment of the present invention to have a granule or shape for easy delivery and scaffold structure. An object of the present invention is providing a BGS that is a shaped particle that may be used as part of a three-dimensional interlocking array of particles. A skilled artisan is aware that the particles may be utilized with inductive graft in which the graft actively facilitates, either directly or indirectly, bone growth. In addition or alternatively, the particles may be utilized for a conductive graft in which the graft is conducive to bone growth but does not actively or directly facilitate it.

The particles will be of an appropriate size such that several individual granules will be used to fill a small void while many can be used to fill larger voids. The three-dimensional structure will allow the granules to fill a volume and, in a specific embodiment, interlock with each other. In another specific embodiment, the particles will be able to interlock with bone. The interlocking will enable the particles to support some mechanical forces while maintaining stability and assist in bone healing. The interlocking feature makes it possible for the particles to resist some shear forces, unlike commercially available products. It will also help to resist migration away from the implant site. The particles will be able to fill odd bone defect shapes and sizes without necessarily needing to carve a larger block to the approximate shape/size. The interlocked particles also provide the ability for the entire implant to behave mechanically more like a single block as compared to current granular products. The shapes would be such that a collection of these particles do not aggregate into a solid, packed volume but instead leave an open, interconnected porosity that is beneficial for bone healing. It is preferred that the shape of the particles and/or the array of the shaped particles allow the engineering or prediction of a specific porosity.

The purpose of having shaped particles is three-fold. First, the capability to interlock provides resistance to shear forces and helps to increase the stability when the graft is packed into a defect. Second, porosity needs to be maintained when the shaped particles are interlocked. It is known in the art that new bone growth can ingress into pores ranging from up to approximately 1000 microns in size, particularly between about 100-400 microns in size. The targeted total porosity will range from 20% to 80%, which means that the array of interlocking shaped particles of the invention will retain open spaces of 20-80% of a specific volume of an array. It is important that a graft material provide adequate porosity to allow ingrowth from the host bone. Alternatively, the material preferably resorbs or degrades away to allow for bone replacement. The preferred embodiment is the combination of both of these properties. Third, the shaped particles provide superior handling of BGS product during transfer into the surgical site.

### EXAMPLE 1

### Generation of Bone Graft Substitutes

Bone graft substitutes are generated by methods as described herein. Generally, a bone material, such as a powder, for example, is provided for the bone graft substitute. In some embodiments, additional material may be added before the pressing steps. For example, a processing aid may be added to the bone material. Upon blending of a processing aid with the bone material, the shaped bone graft substitutes are generated with the novel dry powder compaction processes of the present invention.

In particular embodiments, tricalcium phosphate (TCP) is the bone material utilized. In a particular embodiment, the following TCP powder materials are utilized: P240R L2; and P240RL2-600. In further specific embodiments, both powders were blended with 2.5 wt. % calcium stearate (processing aid and binder) to make 200-250 g batches. Exemplary-shaped TCP JAX granules (such as, for example, granules being about 4 mm tip to tip) were formed using dry powder compaction at 0.20 or 0.25T pressing load at 20 strokes per minute pressing frequency. The granules were sintered using the following exemplary cycle, although one of skill in the art recognizes that these particular steps may be altered and still provide the same or similar result: heating to 650° C. at 1° C./min; followed by dwell for 1 hour; followed by heating to 1200° C. at 2° C./min; followed by dwell for 2 hours; followed by furnace cool (shut off). In a specific embodiment, the speed of the punches is between about 1 and 100, preferably between about 10 and 50, most preferably between about 20 and 40.

Scanning Electron Microscopy (SEM) analysis of the sintered granules was conducted, and methods to perform this are well known in the art. In a specific embodiment, the following process was performed. Granules were placed on double-sided carbon tape laid on an aluminum disk. The disks were sputtered with a 40 nm-thick gold-palladium coating using a Hummer VII sputtering system (Serial #2803025, Anatech, Alexandria, Va.) at the University of Memphis. The samples were then examined using secondary imaging scanning electron microscopy using a Stereoscan 360 SEM (Serial #7805, Leica, Inc., Deerfield, Ill.). The samples were analyzed on both sides (“north” and “south”) at several magnifications (16×, 65×, and 150×) using an accelerating voltage of 7.5 kV and a working distance of approximately 20 mm.

Standard mechanical tests were performed to verify satisfactory results, such as breakage or loss of weight. For example, the friability of the granules was determined both before a manufacturing step and after a manufacturing step, such as before and after sintering. Friability testing was conducted in accordance with USP <1214> standard (“Tablet friability”, United States Pharmaceutical Guidelines, <1216>, USP XXIV, p. 2148-2149 (2000)). An Automated Friabilator EF-2 (Electrolab, distributed by Scheuniger Pharmatron Inc. (Serial No. EF 0006090 XD)) was used. The JAX granules were carefully dusted prior to initial weighing using a cleanroom-grade vacuum cleaner while the JAX were contained in a 3 inch diameter, stainless steel, #70 mesh size (212 μm opening size) sieve ((Part No. 0300019), Newark Wire Cloth, Newark, N.Y.). The dusted JAX granules were added to a balance (Mettler Toledo Balance, Model AT-261 DR (Serial No. 1117201510), with ±0.0001 g accuracy) until a weight of just over 6.5 g was attained in accordance with USP <1216> specification. The friabilitor drum and removable sample tray were cleaned with KimWipes®EX-L tissues (Kimberly-Clark, Roswell, Ga.). The JAX sample, of known mass, was placed in the drum of the Friabilator. The drum was set at the 10° inclination in order to minimize binding together of the JAX during tumbling and facilitating free falling of the individual JAX granules, and then automatically rotated 100 times (i.e. for a period of 4 minutes at 25 r.p.m.), after which the granules were promptly removed. At each turn the granules rolled or slid and fell onto the drum wall or onto each other. The JAX sample was dusted as before, and again weighed to 4 decimal places of a gram using the same balance. The JAX granules were visually inspected for evidence of cracked, cleaved or broken parts. Five JAX sample sets were tested in this manner. The percentage mass loss of each sample after testing was determined. The failure criteria for this test was set at a mass loss of greater than 1%, between the pre- and post-tested samples, in accordance with USP <1216> Tablet Friability.

Table 1 summarizes the exemplary compaction and friability results. The granules pressed with the P240R L2 powder at 0.25 T exhibited low friability (0.42%) prior to sintering. Decreasing the pressing load to 0.20 T increased pre-sintering friability to above 1% (1.31%), but the granules could still be handled. Nevertheless, post-sintering friability was low for both tonnages, with a slight increase at low tonnage (from 0.14 at 0.25 T to 0.23 at 0.20 T). The P240R L2-600 powder could not be compacted at 0.20T with the nominal amount of processing aid (2.5 wt. %). This powder blend could be compacted when the pressing load was increased to 0.25 T, but friability values were high, both pre- and post-sintering (3.29% and 0.81%, respectively). The 3.29% pre-sintering friability was very high, and the granules needed to be handled with great care between pressing and sintering.

TABLE 1
Friability results for the Biotal P240 L2 powders.

| | Tonnage | Friability [%] | Friability [%] |
|---|---|---|---|
| TCP powder batch | [T] | Pre-sintering | Post-sintering |
| P240R L2 | 0.20 | 1.31 | 0.23 |
| | 0.25 | 0.42 | 0.14 |
| P240R L2-600 | 0.20 | Not Compacted | Not Compacted |
| | 0.25 | 3.29 | 0.81 |

### EXAMPLE 2

### Processing Aid Selection for TCP Bone Graft Substitutes

This example characerizes the use of two processing aids, calcium stearate (CaSt) and magnesium stearate (MgSt), for powder compaction of TCP BGS, and in a non-limiting exemplary embodiment are JAX granules. The amount of processing aid (2.5 wt. %) had been selected based on preliminary powder compaction studies. As described herein, TCP JAX granules were powder compacted and sintered at various temperatures and tested for density and friability.

Materials and Methods

Processing of TCP Granules

The TCP powder (Lot # P240R, 75-125 μm, Plasma Biotal, Ltd., Tideswell, UK) was mixed with either 2.5 wt % calcium stearate (Lot# ASC0229, NF Grade, KIC Chemicals, Armonk, N.Y.) or 2.5 wt % magnesium stearate (Lot# ASC0101, NF Grade, KIC Chemicals, Armonk, N.Y.) in a V shell blender. The powder blends were compacted under a load of 2.5 kN at a rate of 30 strokes (parts) per minute to produce the 6-arm TCP JAX shape using a powder compaction withdrawal press (Atlas MPA 6.LL, Precision Rebuilders Inc., Bentonville, Ark., Smith and Nephew #1649). The press set up used in this process consisted of a shelf die with a lower and upper punch (FIG. 2). As shown therein, the shelf-die possesses part of the shape of the part to be compacted to allow for a uniform density distribution for an intricate shape, such as TCP JAX.

The powder was fed into the die cavity through a fill shoe hopper and compressed between the upper and lower punches. The upper punch and shelf die moved to compact the powder, while the lower punch remained stationary (FIG. 1E).

The TCP JAX granules were sintered with a rapid temperature lab furnace (CM Furnaces, Bloomfield, N.J. model 1616FL. Smith and Nephew #1934) equipped with a Eurotherm 2404-P20 microprocessor based programmable controller. The sintering profiles were programmed and monitored using Spec View software. The TCP granules were place on a silicon carbide (SiC) plate which was covered with tricalcium phosphate powder (Lot P224S, Plasma Biotal), to prevent contamination. The sintering profile consisted of a 2° C. per minute ramp from room temperature to 500° C. followed by a 1 hour dwell at 500° C. The final segment consisted of a ramp from 500° C. to the desired temperature (900° C., 1200° C., or 1350° C.) at a rate of 2° C. per minute and held at temperature for 2 hours. These three temperatures were selected to cover a wide range of TCP densities and phase composition (Elliot, 2003). Upon completion of the 2 hour dwell time, the furnace was turned off and the samples were allowed to cool in the furnace.

X-Ray Diffraction Analysis

Quantitative x-ray diffraction (XRD) was used to identify the phases present in the sintered TCP JAX granules. Phase characterization on the sintered TCP JAX granules compacted with 2.5% MgSt was performed at H&M Analytical Labs (Allentown, N.J.). XRD testing was conducted on only one TCP JAX group because the type of processing aid has no effect on the phase composition of the TCP material after sintering. The TCP granules were crushed into powder which was subsequently ground to approximately −325 mesh size (45 microns opening) before being placed on Prolene film. A Huber G670 Guinier diffractometer was used with an angular range of 4° to 100° and a step size of 0.0005°, using copper (Cu) radiation at 40 KV/30 MA. Each sample was run for 10 hours in order to obtain the intensities needed for quantitative analysis. The phases present in each sample were identified using the Powder Diffraction File published by the International Center for Diffraction Data (ICDD) database, which contains reference patterns for known materials, and search/match software for unknowns.

A quantitative analysis was performed on each sample using the Rietveld method, which is a standard for quantitative analyses, with accuracies in the 1% range. The Rietveld method uses the entire x-ray diffraction pattern to quantify phases, unlike other methods which use only portions of the spectrum. The Rietveld method does not use standard materials; it computes the diffraction pattern based on the assumed atomic structure. The computation is then compared to the experimental pattern and the error between the two patterns is determined. Based on these errors, the atomic structure is refined until the differences between the computed pattern and the experimental pattern cannot get any smaller. At this point, the refined pattern's parameters are used to compute the weight fractions of each phase. During the analysis of these samples, the following phases were detected: hydroxyapatite (HA) and beta and alpha tricalcium phosphate (TCP).

TCP Granule Density

The envelope (bulk) density of the sintered TCP JAX granules was measured in order to determine the effect of sintering cycle on the density of the granules and in order to determine if the dissolution rate could be related to a change in density post sintering. Envelope density measurement determines the density of the sample including the open and closed pore spaces within the sample. Envelope density was measured using a GeoPyc 1360 dry powder pycnometer (Micromeritics®, Norcross, Ga., USA). A sample consisted of five TCP JAX granules of the same sintering cycle. These granules were weighed, and then placed in a bed of DryFlo®. As the DryFlo® is agitated, it conforms to the contours of the TCP JAX and forms a tight fitting ‘envelope’ around the TCP JAX granules. The GeoPyc measures the volume of the granules and uses the previously measured weight to calculate the density of the granules (density=mass/volume). Three runs containing five TCP JAX granules each were performed per sintering condition. The average of the 3 runs is reported as the average density.

Friability

Friability testing was conducted in accordance with USP XXIV <1216> Tablet Friability test specifications using an Automated Friabilator (Electrolab, Model EF-2, Serial No. EF 0006090 XD, S&N No. 1657). TCP JAX granules weighing just over 6.5 g were placed in a 3 inch diameter, stainless steel, #70 mesh size (212 μm opening size) sieve ([Part No. 00490988], Newark Wire Cloth, Newark, N.Y.) and were carefully dusted using a clean vacuum duster. The TCP JAX sample was placed in the drum of the Friabilator that was set at the 100 inclination. The test cycle consisted of 100 rotations (i.e. for a period of 4 minutes at 25 r.p.m.). The TCP JAX sample was dusted as before, and again weighed to 4 decimal places of a gram using the same balance (Mettler Toledo Balance, Model AG204, Serial No. 1119343522, S&N No. C1634.8, ±0.0001 g accuracy). The TCP JAX granules were visually inspected for evidence of cracked, cleaved or broken parts. One sample of TCP JAX granules per Level was tested for each batch. The percentage mass loss of each sample after testing was determined. The failure criteria for this test was set at a mass loss of greater than 1.0%, between the pre- and post-tested samples, and no cracked, cleaved or broken parts (United States Pharmaceutical Guidelines, 2000).

Results and Discussion

XRD Analysis

Table 2 shows the x-ray analysis results for the sintered TCP granules and the un-sintered TCP powder. The un-sintered granules were composed of 100% HA like phase. Sintering TCP granules at 900° C. produced a mixture of 93% beta TCP and 7% HA-like phase (untransformed original precursor phase). Sintering TCP granules at 1100° C. and 1200° C. produced 100% beta TCP phase. Sintering TCP granules at 1350° C. produced a mixture of 21% alpha TCP phase and 79% beta TCP phase (Table 2).

TABLE 2
Quantitative XRD analysis results of all TCP samples (N = 1).

| | Amount beta | Amount HA-like* | Amount alpha |
|---|---|---|---|
| Sintering Condition | TCP (wt. %) | (wt. %) | TCP (wt %) |
| Un-sintered powder | 0.0 | 100 | 0.0 |
| 900° C./2 hr | 93 | 7 | 0.0 |
| 1200° C./2 hr | 100 | 0.0 | 0.0 |
| 1350° C./2 hr | 79 | 0.0 | 21 |

*HA-like is calcium-deficient apatite associated with untransformed original precursor phase with Ca/P ratio of 1.5

Density

The results of the density tests can be seen in Table 3. The type of processing aid used in the compaction of the TCP JAX (MgSt or CaSt) had no statistically significant (p>0.10) effect on the post sintered dimensions or density. There was a statistical difference between the granules sintered at 900° C. compared to those sintered at 1200° C. and 1350° C. for both the MgSt and CaSt granules (p<<0.05) because sintering at 900° C. produces an incomplete fusion of the TCP powder particles and density values below the maximum achievable.

TABLE 3
Envelope density of TCP granules measured at different sintering
conditions (N = 3; average ± standard deviation).

| | Average density | Average density |
|---|---|---|
| Sintering Condition | 2.5% MgSt (g/cm³) | 2.5% CaSt (g/cm³) |
| 900° C./2 hr | 1.69 ± 0.01 | 1.53 ± 0.09 |
| 1200° C./2 hr | 2.70 ± 0.02 | 2.69 ± 0.09 |
| 1350° C./2 hr | 2.65 ± 0.04 | 2.67 ± 0.17 |

Friability

Table 4 shows the results of the friability tests performed before and after sintering for the MgSt and CaSt blended TCP JAX. The high friability values for the 900° C. MgSt and CaSt TCP JAX may be attributed to the incomplete sintering which also resulted in lower density values previously discussed. The CaSt TCP JAX passed (≦1.0% weight loss) in all pre- and post-sintered conditions. The MgSt TCP JAX also passed the weight loss requirements at all conditions (≦1.0% weight loss), however some of the MgSt granules were broken during the friability test, which resulted in a failure of this test for the MgSt TCP JAX granules. Based on the friability results, calcium stearate is the preferred processing aid over magnesium stearate for powder compaction of TCP JAX.

TABLE 4
Friability Measurements on un-sintered and
sintered TCP JAX granules (N = 1).

| | % Weight Loss | | % Weight Loss | |
|---|---|---|---|---|
| Sintering | (2.5% MgSt) | | (2.5% CaSt) | |
| Condition | Pre-sintered | Post-sintered | Pre-sintered | Post-sintered |
| 900° C./2 hr | 0.78 | 0.92 | 0.64 | 1.0 |
| 1200° C./2 hr | 0.75 | 0.41 | 0.64 | 0.18 |
| 1350° C./2 hr | 0.49 | 0.38 | 0.49 | 0.23 |

### Conclusions

TCP JAX powder compacted with either 2.5% magnesium stearate or 2.5% calcium stearate by weight that had been sintered at 900° C., 1200° C., and 1350° C. for 2 hours at each temperature were characterized for density and friability. In specific embodiments, the results show that the type of processing aid used in the compaction of the TCP JAX had no statistically significant effect on the post-sintered density. Furthermore, the TCP JAX granules processed with calcium stearate passed the friability test (≦1.0% weight loss with no breakage) in all pre- and post-sintered conditions, while the TCP JAX granules processed with magnesium stearate failed the friability test due to the breakage of a few granules at each condition, although the weight loss requirements were passed. Therefore, in preferred embodiments, calcium stearate is a preferred processing aid for powder compaction of TCP JAX granules, although in alternative embodiments magnesium stearate is utilized.

### EXAMPLE 3

### Biological Agents

In a preferred embodiment of the present invention, a biological agent is included in the bone material, such as a powder, or on the generated shape, or both. Examples include antibiotics, growth factors, proteins, fibrin, bone morphogenetic factors, bone growth agents, chemotherapeutics, pain killers, bisphosphonates, strontium salt, fluoride salt, magnesium salt, sodium salt, or mixtures thereof.

In contrast to administering high doses of antibiotic orally to an organism, the present invention allows antibiotics to be included within and/or on the composition for a local administration. This reduces the amount of antibiotic required for treatment of or prophalaxis for an infection. Administration of the antibiotic in the BGS would also allow less diffusing of the antibiotic, particularly if the antibiotic is contained within a partially confining material, such as a fibrin matrix. Alternatively, the particles of the present invention may be coated with the antibiotic and/or contained within the particle. Examples of antibiotics are tetracycline hydrochloride, vancomycin, cephalosporins, and aminoglycocides such as tobramycin and gentamicin.

Growth factors may be included in the BGS for a local application to encourage bone growth. Examples of growth factors which may be included are platelet derived growth factor (PDGF), transforming growth factor β (TGF-β), insulin-related growth factor-I (IGF-I), insulin-related growth factor-II (IGF-II), fibroblast growth factor (FGF), beta-2-microglobulin (BDGF II) and bone morphogenetic protein (BMP). The particles of the present invention may be coated with a growth factor and/or contained within the particle or the suspension material.

Bone morphogenetic factors may include growth factors whose activity is specific to osseous tissue including proteins of demineralized bone, or DBM (demineralized bone matrix), and in particular the proteins called BP (bone protein) or BMP (bone morphogenetic protein), which actually contains a plurality of constituents such as osteonectin, osteocalcin and osteogenin. The factors may coat the shaped particles of the present invention and/or may be contained within the particles or the suspension material.

Bone growth agents may be included within the compositions of the present invention in a specific embodiment. For instance, nucleic acid sequences that encode an amino acid sequence, or an amino acid sequence itself may be included in the suspension material of the present invention wherein the amino acid sequence facilitates bone growth or bone healing. As an example, leptin is known to inhibit bone formation (Ducy et al., 2000). Any nucleic acid or amino acid sequence that negatively impacts leptin, a leptin ortholog, or a leptin receptor may be included in the composition. As a specific example, antisense leptin nucleic acid may be transferred within the compositions of the invention to the site of a bone deficiency to inhibit leptin amino acid formation, thereby avoiding any inhibitory effects leptin may have on bone regeneration or growth. Another example is a leptin antagonist or leptin receptor antagonist.

The nucleic acid sequence may be delivered within a nucleic acid vector wherein the vector is contained within a delivery vehicle. An example of such a delivery vehicle is a liposome, a lipid or a cell. In a specific embodiment, the nucleic acid is transferred by carrier-assisted lipofection (Subramanian et al., 1999) to facilitate delivery. In this method, a cationic peptide is attached to an M9 amino acid sequence and the cation binds the negatively charged nucleic acid. Then, M9 binds to a nuclear transport protein, such as transportin, and the entire DNA/protein complex can cross a membrane of a cell.

An amino acid sequence may be delivered within a delivery vehicle. An example of such a delivery vehicle is a liposome. Delivery of an amino acid sequence may utilize a protein transduction domain, an example being the HIV virus TAT protein (Schwarze et al., 1999).

In a preferred embodiment, the biological agent of the present invention has high affinity for a fibrin matrix.

In a specific embodiment, the particle of the present invention may contain within it and/or on it a biological agent which would either elute from the particle as it degrades or through diffusion.

The biological agent may be a pain killer. Examples of such a pain killer are lidocaine hydrochloride, bipivacaine hydrochloride, and non-steroidal anti-inflammatory drugs such as ketorolac tromethamine.

Other biological agents that may be contained on or in the compositions of the present invention are chemotherapeutics such as cis-platinum, ifosfamide, methotrexate and doxorubicin hydrochloride. A skilled artisan is aware which chemotherapeutics would be suitable for a bone malignancy.

Another biological agent that may be included in the BGS of the present invention is a bisphosphonate. Examples of bisphosphonates are alendronate, clodronate, etidronate, ibandronate, (3-amino-1-hydroxypropylidene)-1,1-bisphosphonate (APD), dichloromethylene bisphosphonate, aminobisphosphonatezolendronate and pamidronate.

The biological agent may be either in purified form, partially purified form, commercially available or in a preferred embodiment are recombinant in form. It is preferred to have the agent free of impurities or contaminants.

Addition of Fibrinogen to the Composition

It is advantageous to include into the composition of shaped particles any factor or agent that attracts, enhances, or augments bone growth. In a specific embodiment, the composition further includes fibrinogen which, upon cleaving by thrombin, gives fibrin. In a more preferred embodiment, Factor XIII is also included to crosslink fibrin, giving it more structural integrity.

Fibrin is known in the art to cause angiogenesis (growth of blood vessels) and in an embodiment of the present invention acts as an instigator of bone growth. It is preferred to mimic signals which are normally present upon, for instance, breaking of bone to encourage regrowth. It is known that fibrin tends to bind growth factors which facilitate this regrowth.

In an object of the present invention the inclusion of fibrin into the composition is twofold: 1) to encourage bone growth; and 2) to act as a delivery vehicle.

The fibrin matrix is produced by reacting three clotting factors—fibrinogen, thrombin, and Factor XIII. These proteins may be manufactured using recombinant techniques to avoid issues associated with pooled-blood products and autologous products. Currently, the proteins are supplied in a frozen state ready for mixing upon thawing. However, lypholization process development allows that the final product will either be refrigerated or stored at room temperature and reconstituted immediately prior to use. In a preferred embodiment, the clotting factors are recombinant in form.

Only fibrinogen and thrombin are required to produce a fibrin matrix in its simplest form. However, the addition of Factor XIII provides the ability to strengthen the matrix by means of cross linking the fibrin fibrils. Specific mixtures of the three proteins may be provided to generate the appropriate reaction time, degradation rate, and elution rate for the biological agents.

Modifications can be made by altering the fibrin component. One expected modification would be to use hyaluronic acid or a collagen gel instead of or in addition to a fibrin component. Other variations may be inclusion of additional clotting factors in the fibrin matrix. Additional examples of clotting factors are known in the art and may be used, but in a specific embodiment they are clotting factors relevant to a bone disorder. The clotting factors may be purified, partially purified, commercially available, or in recombinant form. In a specific embodiment thrombin alone is used with the patient's own blood or bone marrow aspirate to produce a fibrin matrix.

In a specific embodiment, a biological agent as described above is contained within the fibrin matrix.

For all formulations, the processing aid was stearic acid. The equipment used was a manual hydraulic press, punches used for conventional compression/tableting, and wood blocks for support/guides. Other blends including other allograft (such as human bone or DBM), synthetic or ceramic (such as calcium sulfate or calcium phosphate), or bioactive agents (such as antibiotic, BMPs, acids, and the like), individually or as a mix of two or more of the aforementioned components can potentially be compacted to produce a tablet or a JAX™ shape or other shape. A processing aid, or a blend of two or more processing aids (magnesium stearate, calcium stearate, and stearic acid), may be used in the compaction process.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

### REFERENCES

All patents and publications mentioned in the specification are indicative of the level of those skilled in the art to which the invention pertains. All patents and publications are herein incorporated by reference to the same extent as if each individual publication was specifically and individually indicated to be incorporated by reference.

### PATENTS

U.S. Pat. No. 4,384,834 issued May 24, 1983.
U.S. Pat. No. 4,619,655 issued Oct. 28, 1986.
U.S. Pat. No. 5,017,122 issued May 21, 1991.
U.S. Pat. No. 5,158,728 issued Oct. 27, 1992.
U.S. Pat. No. 5,366,507 issued Nov. 22, 1994.
U.S. Pat. No. 5,449,481 issued Sep. 12, 1995.
U.S. Pat. No. 5,569,308 issued Oct. 29, 1996.
U.S. Pat. No. 5,603,880 issued Feb. 18, 1997.
U.S. Pat. No. 5,614,206 issued Mar. 25, 1997.
U.S. Pat. No. 5,654,003 issued Aug. 5, 1997.
U.S. Pat. No. 5,762,978 issued Jun. 9, 1998.
U.S. Pat. No. 5,807,567 issued Sep. 15, 1998.
U.S. Pat. No. 6,106,267 issued Aug. 22, 2000.
U.S. Pat. No. 6,030,636 issued Feb. 29, 2001.
U.S. Pat. No. 6,177,125 issued Jan. 23, 2001.

### PUBLICATIONS

Bauer, T. and S. Smith, “Bioactive Material in Orthopaedic Surgery: Overview and Regulatory Considerations”, Clinical Orthopedics and Related Research, 395, 11-22 (2002).
Elliot, J. C., Structure and Chemistry of the Apatites and Other Calcium Orthophosphates, Studies in Inorganic 18, Elsevier, The Netherlands, pp. 48-49 (2003).
Medica Data International, Inc., Report #RP-591149, Chapter 3: Applications for Bone Replacement Biomaterials and Biological Bone Growth Factors (2000).
Orthopaedic Network News, Vol. 11, No 4, October 2000, pp. 8-10.
“Tablet friability”, United States Pharmaceutical Guidelines, <1216>, USP XXIV, p. 2148-2149 (2000).
Unkel, R., “Basics of Compacting” Presentation at Basic Powder Metallurgy, An Introductory Short Course, Lisle, Ill., 1998.

One skilled in the art readily appreciates that the present invention is well adapted to carry out the objectives and obtain the ends and advantages mentioned as well as those inherent therein. Particles, compositions, treatments, methods, kits, procedures and techniques described herein are presently representative of the preferred embodiments and are intended to be exemplary and are not intended as limitations of the scope. Changes therein and other uses will occur to those skilled in the art which are encompassed within the spirit of the invention or defined by the scope of the pending claims.

1. A method of manufacturing at least one shaped bone graft substitute comprising the steps of:
providing a bone material; and
subjecting said bone material to a press, wherein said press comprises at least:
a first punch comprising a configuration to impart at least a portion of the shape of said bone graft substitute to the bone material;
a shelf die containing a cavity for receiving at least one punch, said cavity comprising:
a shelf;
a configuration to impart at least a portion of the shape of said bone graft substitute; and
a configuration concentrically surroundable to said first punch and moveable axially thereabout; and
a second punch, wherein said second punch is moveable into a part of said cavity, said part bounded by the shelf of the shelf die, wherein said second punch is opposable to the first punch, and wherein following said subjecting step a bone graft substitute having a substantially non-linear contour is manufactured.

2. The method of claim 1, wherein said bone material comprises a powder.

3. The method of claim 2, wherein particles of said material comprising a powder are less than about 10 millimeters in diameter.

4. The method of claim 3, wherein particles of said material comprising a powder are less than about 250 μm in diameter.

5. The method of claim 4, wherein particles of said material comprising a powder are in a range of about 50 to 180 μm in diameter.

6. The method of claim 1, wherein said providing a bone material comprises the steps of:
providing at least one bone material; and
generating a granular or granulated form of said material.

7. The method of claim 1, wherein said bone material is an allograft material, a ceramic material, a metal, a polymer or a combination thereof.

8. The method of claim 1, further comprising the step of adding at least one processing aid composition to the bone material, to the bone graft substitute, or to both.

9. The method of claim 8, wherein said processing aid composition is selected from the group consisting of stearic acid, calcium stearate, magnesium stearate, natural polymer, synthetic polymer, sugar and combinations thereof.

10. The method of claim 9, wherein said natural polymer is starch, gelatin, or a combination thereof.

11. The method of claim 9, wherein said synthetic polymer is methylcellulose, sodium carboxymethylcellulose, or hydropropylmethylcellulose, or a combination thereof.

12. The method of claim 9, wherein said sugar is glucose.

13. The method of claim 7, wherein said bone material is a ceramic material.

14. The method of claim 13, wherein said ceramic material comprises a calcium salt.

15. The method of claim 13, wherein said ceramic material is selected from the group consisting of calcium sulphate, alumina, silica, calcium carbonate, calcium phosphate, calcium tartarate, bioactive glass, zirconia, and a combination thereof.

16. The method of claim 15, wherein said calcium phosphate is tricalcium phosphate or hydroxylapatite.

17. The method of claim 7, wherein said allograft bone material is cortical-cancellous bone.

18. The method of claim 7, wherein said allograft bone material is demineralized bone matrix.

19. The method of claim 1, further comprising the step of adding a biological agent to the bone material, to the bone graft substitute, or both.

20. The method of claim 19, wherein said biological agent is selected from the group consisting of a growth factor, an antibiotic, a strontium salt, a fluoride salt, a magnesium salt, a sodium salt, a bone morphogenetic factor, a chemotherapeutic agent, a pain killer, a bisphosphonate, a bone growth agent, an angiogenic factor, and a combination thereof.

21. The method of claim 20, wherein said growth factor is selected from the group consisting of platelet derived growth factor (PDGF), transforming growth factor β (TGF-β), insulin-related growth factor-I (IGF-I), insulin-related growth factor-II (IGF-II), fibroblast growth factor (FGF), beta-2-microglobulin (BDGF II), bone morphogenetic protein (BMP), and a combination thereof.

22. The method of claim 20, wherein said antibiotic is selected from the group consisting of tetracycline hydrochloride, vancomycin, cephalosporins, and aminoglycocides such as tobramycin, gentamicin, and a combination thereof.

23. The method of claim 20, wherein said bone morphogenetic factor is selected from the group consisting of proteins of demineralized bone, demineralized bone matrix (DBM), bone protein (BP), bone morphogenetic protein (BMP), osteonectin, osteocalcin, osteogenin, and a combination thereof.

24. The method of claim 20, wherein said chemotherapeutic agent is selected from the group consisting of cis-platinum, ifosfamide, methotrexate, doxorubicin hydrochloride, and a combination thereof.

25. The method of claim 20, wherein said pain killer is selected from the group consisting of lidocaine hydrochloride, bipivacaine hydrochloride, non-steroidal anti-inflammatory drugs such as ketorolac tromethamine, and a combination thereof.

26. The method of claim 1, wherein said bone graft substitute comprises a diameter of at least about 3 millimeters at its greatest width.

27. The method of claim 1, wherein said bone graft substitute comprises a diameter of no more than about 4 millimeters at its greatest width.

28. The method of claim 1, wherein said method further comprises the step of sintering the bone graft substitute.

29. A method of manufacturing at least one shaped bone graft substitute comprising the steps of:
providing at least one bone material; and
subjecting said bone material to a press, wherein said press comprises:
a shelf die comprising a configuration to impart at least a portion of the shape of said bone graft substitute;
a lower punch positionable generally below said shelf die and comprising a configuration to impart at least a portion of the shape of said bone graft substitute; and
an upper punch positionable generally above said shelf die, wherein following said subjecting step, a bone graft substitute having a substantially non-linear contour is manufactured.

30. A method of manufacturing a shaped bone graft substitute from a bone material, said method comprising the steps of:
providing a stationary lower punch having a configuration to impart at least a portion of said shape upon said bone material;
providing a shelf die having at least one cavity and positionable generally above the stationary lower punch, said cavity comprising a configuration to impart at least a portion of said shape upon said bone material, said lower punch positionable generally below the cavity of the shelf die;
providing a moveable upper punch positionable generally above the cavity of the shelf die;
introducing the bone material into the cavity; and
moving the moveable upper punch to pressably contact the bone material in opposition to the stationary lower punch, whereby said steps form the bone material into the shaped bone graft substitute.

31. A method for manufacturing a shaped bone graft substitute, said method comprising the steps of:
providing:
a first punch having a first contact surface configured to effect a relief profile onto a surface of a bone material;
a second punch having a second contact surface; and
a shelf die having at least one cavity, said cavity comprising a surface configured to effect a relief profile onto a surface of the material;
introducing the material into the cavity;
positioning the shelf die generally in alignment with the first and second punches; and
moving the second punch to pressably contact the material in the cavity to effect the desired relief profile on the surface of the material;
whereby said moving step forms the material into the shaped bone graft substitute.

32. The method of claim 31, wherein the steps of moving the second punch to pressably contact the material effects a substantially uniform distribution of pressure within said material.

33. The method of claim 31, wherein the punches are configured such that the shape of the bone graft substitute resulting from the method is a shape selected from the group consisting of a six-armed toy jack, a five-armed toy jack, a ring, or a combination thereof.

34. The method of claim 31, wherein the moving step applies a force to the material in a range of about 0.1 to about 5 tons.

35. The method of claim 31, wherein the moving step applies a force to the material in a range of about 0.2 to about 2 tons.

36. The method of claim 31, wherein the moving step applies a force to the material in a range of about 0.1 to about 0.3 ton.

37. The method of claim 31, wherein said bone material comprises a tricalcium phosphate powder.

38. A method of manufacturing a shaped bone graft substitute from a bone material, said method comprising the steps of:
providing a first punch having a configuration to impart at least a portion of said shape upon said bone material;
providing a shelf die having at least one cavity and positionable generally in alignment with the first punch, said cavity comprising a configuration to impart at least a portion of said shape upon said bone material;
providing a second punch positionable generally in alignment with the cavity of the shelf die;
introducing the bone material into the cavity; and
pressably contacting the second punch to the bone material in opposition to the first punch, whereby said steps form the bone material into a bone graft substitute having a substantially non-linear contour shape.

39. The method of claim 38, wherein said substantially non-linear contour shape is further defined as comprising a relief profile.

40. The method of claim 38, wherein the first punch is stationary.

41. The method of claim 38, wherein the first punch is moveable.

42. The method of claim 38, wherein the die is stationary.

43. The method of claim 38, wherein the die is moveable.

44. An apparatus for shaping a bone graft substitute from bone material, said apparatus comprising:
a first punch having a top surface comprising a relief profile, said first punch positioriable generally below a shelf die;
a shelf die having at least one cavity and positionable generally above the first punch, wherein the contour of the wall of said cavity comprises a relief profile; and
a moveable second punch opposable to the first punch.

45. The apparatus of claim 44, wherein said first punch is stationary.

46. The apparatus of claim 44, wherein the relief profile of the die cavity and the relief profile of the lower punch are substantially the same.

47. An apparatus for manufacturing a bone graft substitute from a bone material, said apparatus comprising:
a first punch comprising a first contact surface having a profile configured to effect a relief profile onto a surface of the bone material;
a second punch having a second contact surface, the second contact surface positioned in general alignment with the first contact surface; and
a moveable die having at least one cavity, wherein the cavity comprises a surface configured to effect a relief profile onto a surface of the bone material, the moveable die being positionable generally in between the first and second punches.

48. A bone graft substitute manufactured by the method of claim 1.

49. A bone graft substitute manufactured by the method of claim 29.

50. A bone graft substitute manufactured by the method of claim 30.

51. A bone graft substitute manufactured by the method of claim 31.

52. A bone graft substitute manufactured by the method of claim 38.
